(19) United States
(12) Patent Application Publication
(10) Pub. No.: US 2025/0393069 A1
(43) Pub. Date: Dec. 25, 2025

(54) PER-LINK (TWT, R-TWT) PROCEDURE SUPPORT AND STATE SWITCHES FOR EMLSR OR ELMLR CO-AFFILIATED STATIONS

(71) Applicant: CANON KABUSHIKI KAISHA, Tokyo (JP)

(72) Inventors: Pascal VIGER, JANZE (FR); Mickaël LORGEOUX, RENNES (FR); Julien SEVIN, SAINT AUBIN DU CORMIER (FR)

(21) Appl. No.: 18/877,164

(22) PCT Filed: Jun. 28, 2023
(86) PCT No.: PCT/EP2023/067586

§ 371 Date: Dec. 19, 2024

(30) Foreign Application Priority Data
Jul. 1, 2022 (GB) 2209734.9
Mar. 14, 2023 (GB) 2303749.2

(51) Int. Cl. H04W 74/0816; H04W 74/00; H04W 76/15

(52) U.S. Cl. CPC H04W 74/0816; H04W 74/002; H04W 76/15

(57) ABSTRACT

A non-AP MLD operates in an EML mode that applies in a set of EML links. The non-AP MLD receives, by a first affiliated station, a first beacon frame over a first link of the EML links, the first beacon frame including a TBTT related to a second beacon frame. Moreover, the non-AP MLD configures the first affiliated station to be in a receiving state at the TBTT to receive the second beacon frame.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE®) provides a great number of mechanisms for wireless communications between stations (STAs).

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D2.0 version (May 2022, below “D2.0 standard”) introduces the Multi-Link (ML) Operation (MLO). MLO improves data throughput by allowing communications between STAs over multiple concurrent and non-contiguous communication links.

MLO enables a non-AP (Access Point) MLD (ML Device) to register with an AP MLD, i.e. to discover, authenticate, associate and set up multiple links with the AP MLD. Each link enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

With the introduction of MLO and of spatial multiplexing capabilities of the MLDs, new Operating Modes (OM) referred to as Enhanced Multi-Link Operating Mode (EML OM), have been introduced in the D2.0 standard, namely the EMLSR (Enhanced Multi-Link Single Radio) mode and the EMLMR (Enhanced Multi-Link Multi-Radio) mode.

The non-AP MLDs declare their support of the EML Operating Modes (known as EML Capabilities) to the AP MLD during the association phase. In operation mode, the activation and the deactivation of an EML Operation Mode is initiated by the non-AP MLD which sends a specific EHT action frame referred to as “EML OM Notification”. The D2.0 standard states that the two EMLSR and EMLMR modes are mutually exclusive.

The EMLMR mode, once activated, allows the non-AP MLD to simultaneously listen to a set of enabled links (so-called EMLMR links, usually made of two enabled links) to receive an initial frame transmitted by the AP MLD to initiate frame exchange and next to aggregate some physical resources of its different radios used on different links (so-called EMLMR links) in order to transmit or receive data up to a pre-defined number of supported Rx/Tx spatial streams, over only one EMLMR link at a time, usually the link over which the initial frame is received. The number may be greater than the number of supported Rx/Tx spatial streams of each radio.

The EMLSR mode, once activated, allows a non-AP MLD to simultaneously listen to a set of enabled links (so-called EMLSR links, usually made of two enabled links) to receive an initial control frame (e.g. an MU-RTS trigger frame, a BSRP trigger frame) from the AP MLD to initiate frame exchange and next to perform data frames exchange with the AP MLD over only one EMLSR link at a time, usually the link over which the initial control frame is received.

This shows that the EMLSR (or EMLMR) links are not fully independent one of the other.

In addition, the non-AP MLD has also the ability to initiate itself the frame exchange with the AP MLD over one EMLSR or EMLMR link for transmitting uplink data. In such a case, a STA affiliated to a non-AP MLD operating in the EMLSR or EMLMR mode does not need to transmit an initial Control frame or an initial frame to initiate frame exchanges with the AP MLD (untriggered UL transmission) and follows the rules defined in sections 10.3.2.4 (Setting and resetting the NAV) and 10.23.2 (HCF contention based channel access (EDCA)) to access the wireless medium as specified in the IEEE 802.11-2020 standard.

The EML modes mechanism coexist with other 802.11 mechanisms. Some of them (also referred to as “link-specific procedures”) are defined on a given radio medium, hence operate on a given link of the EMLSR (or EMLMR) links, independently of the other links. For instance, this is the case of the so-called Target Wake Time (TWT) procedure or of its recent adaptation known as Restricted Target Wake Time procedure (referred to as rTWT or R-TWT).

Implementations of the EML modes may be prejudicial to an efficient functioning of those link-specific procedures. As an example, a network activity of a non-AP MLD on one first EMLSR (or EMLMR) link may prevent the non-AP MLD to be aware of the link-specific procedure, e.g. of a rTWT service period, on another EMLSR (or EMLMR) link because the non-AP MLD is not able to listen over the other link while operating on the first link.

There is a need to improve the coexistence of the EML modes with link-specific procedures.

### SUMMARY OF INVENTION

The inventors have noticed that the inability of the non-AP MLD to participate in the link-specific procedure comes from a failure of that MLD in receiving the beacon frames announcing such procedure over the other link, due to the network operation of the non-AP MLD on the first link.

It is thus a broad objective of the present invention to favor the reception of the beacon frames. This should provide enhanced link-specific procedures adapted to the EML modes, which take into account the use of the EML modes.

In this context, there is provided a communication method in a wireless network, comprising, at a non-access point, non-AP, multi-link device, MLD operating in an Enhanced Multi-Link, EML, mode that applies in a set of EML links:
receiving, by a first affiliated station, a first beacon frame over a first link of the EML links, the first beacon frame including a Target Beacon Transmission Time, TBTT, related to a second beacon frame; and
configuring the first affiliated station to be in a receiving state at the TBTT to receive the second beacon frame.

It is understood that the first affiliated station operates on the first link, while one or more other affiliated stations operate on the other EML link(s).

Accordingly, the non-AP MLD takes into account the expected time (TBTT) of the next beacon frame to be received over the first link to configure itself in an appropriate receiving mode (at the corresponding first affiliated station), regardless of any network activity over the other link(s) of the EML links.

As a consequence, the reception of the next beacon frame is guaranteed, hence the non-AP MLD becomes aware of any first-link-specific procedure announced by the next beacon frame. Optional features of the invention are defined below with reference to a method, while they can be transposed into device features.

In some embodiments, configuring the first affiliated station includes ending an on-going frame exchange over a second link of the EML links and switching the first affiliated station into an operation state compliant with receiving the second beacon frame.

It is understood that, due to the frame exchange over the second link, the first affiliated station is initially in a disabled frame exchange state.

The non-AP MLD therefore takes a decision, at the expected time of the next beacon frame, to stop a current frame exchange in order to change the first affiliated station from its disabled frame exchange state into a receiving state adapted to receive the next beacon frame. The interruption of the frame exchange therefore allows the beacon frame to be correctly received over the first link.

In specific embodiments, switching into the operation state compliant with receiving the second beacon frame includes switching the first affiliated station into a listening operation state. This advantageously allows a second affiliated station to listen on its respective second EML link, for example to simultaneously receive another beacon frame.

In specific embodiments, a second affiliated station shall ignore any initial frame that triggers a frame exchange sequence over the second link and that overlaps in time the first beacon frame on the first link.

It is understood that the second affiliated station operates on the second link different from the first link.

This configuration ensures the non-AP MLD receives the entire expected beacon frame, regardless of the network activity on the second link.

More generally, this configuration concerns a communication method in a wireless network, comprising, at a non-access point, non-AP, multi-link device, MLD operating in an Enhanced Multi-Link, EML, mode that applies in a set of EML links:
configuring a second affiliated station of the non-AP MLD to ignore any received initial frame that triggers a frame exchange sequence over a second link of the EML links and that overlaps in time a beacon frame received by a first affiliated station of the non-AP MLD over a first link of the EML links.

In specific embodiments, switching into the operation state compliant with receiving the second beacon frame includes switching the first affiliated station into an enabled frame exchange state. This configuration prevents the non-AP MLD receiving the beacon frame to switch on the second link, for instance when the AP MLD sends an initial (control) frame over the second link simultaneously to the second beacon frame.

In some embodiments, configuring the first affiliated station includes switching the first affiliated station from a listening operation state into an enabled frame exchange state. Again, this prevents the non-AP MLD receiving the beacon frame to switch on the second link, for instance when the AP MLD sends an initial (control) frame over the second link simultaneously to the second beacon frame.

In some embodiments, configuring the first affiliated station includes ending an on-going frame exchange over the first link and maintaining the first affiliated station in an enabled frame exchange state.

This means that the first affiliated station does not switch back to the listening operation state as soon as the frame exchange ends. The frame exchange end may correspond to an end of a gained transmission opportunity or may be voluntarily triggered by the non-AP MLD due to a close time proximity of the TBTT, in order to configure itself for receiving the second beacon frame.

These embodiments avoid useless state switches of the affiliated station, while guaranteeing correct reception of the beacon frame.

In specific embodiments, the first affiliated station is maintained in the enabled frame exchange state if a time distance of the frame exchange end to the TBTT is smaller than a predefined threshold. For example, the predefined threshold is at least the sum of:
a transition period needed by the non-AP MLD to switch the state of its affiliated stations from the listening operation state to the enabled or disabled frame exchange states; and
a transition period needed by the non-AP MLD to switch the state of its affiliated stations from the enabled or disabled frame exchange state to the listening operation state.

This allows to finely control which non-AP MLDs can benefit from the maintaining in the enabled frame exchange state and which non-AP MLDs ending their frame exchanges can still try to have network activity on the second link. Use of the wireless network is therefore improved.

In some embodiments, configuring the first affiliated station is triggered at least a first determined delay before the TBTT. For example, the first determined delay belongs to the group comprising: an EMLSR active switch delay, an EMLMR active switch delay and a maximum of the EMLSR and EMLMR active switch delays. This configuration ensures the first affiliated station is in the receiving state at the TBTT, meaning it can correctly receive the expected second beacon frame.

In some embodiments, the second beacon frame schedules a service period on the first link, and upon ending a frame exchange within the service period, maintaining the first affiliated station in an enabled frame exchange state until an end of the service period. In this configuration, the first affiliated station is no longer automatically switched back to the listening operation state as soon as the frame exchange ends, but continues in the enabled frame exchange state until the end of the entire service period (e.g. rTWT SP). This increases opportunities for the non-AP MLD to exchange frames during the service period, hence improves network efficiency.

In some embodiments, the second beacon frame schedules a service period on the first link, and switching the first affiliated station in an enabled frame exchange before the start of the service period and maintaining it in the enabled frame exchange state until the end of the service period. In this configuration, the first affiliated station is in the enabled frame exchange state for the entire service period (e.g. rTWT SP). This increases opportunities for the non-AP MLD to exchange frames during the service period, hence improves network efficiency.

In specific embodiments, the method comprises, at the end of the service period, switching the first affiliated station from the enabled frame exchange state to a listening operation state.

In some embodiments, the second beacon frame includes another TBTT related to a third beacon frame that schedules a TWT service period on the first link, and

in case the scheduled TWT service period is signaled with a TWT persistence, a frame exchange performed by a second affiliated station over a second link of the EML links is continued without configuring the first affiliated station to be in a receiving state at the other TBTT to receive the third beacon frame over the first link.

It is understood that the TWT persistence (Broadcast TWT Persistence field in the TWT Element) indicates the number of TBTTs during which the Broadcast TWT service periods corresponding to this broadcast TWT Parameter set are present. Since the TWT service periods are repeated, there is no need for the non-AP MLD to obtain the next beacon frame announcing the same information. These embodiments thus avoid the network activity on the second link to be interrupted. This improves network efficiency.

In some embodiments, the second beacon frame schedules a quiet period on the first link, and at a time of the quiet period, switching the first affiliated station to a disabled frame exchange state until an end of the quiet period. This means that at the time of the quiet period, a second affiliated station operating on a second link of the EML links is switched to an enabled frame exchange state until the end of the quiet period. The non-AP MLD can therefore start quickly a frame exchange over the second link, hence improving the network efficiency.

In some embodiments, the method further comprises, by the non-AP MLD, transmitting to the AP MLD an indication to schedule, in future beacon frames, service periods for the non-AP MLD that do not overlap in time any beacon frame transmitted by the AP MLD over a second link of the EML links. Such indication ensures for the non-AP MLD that it will be able to receive the beacon frames over the second link, regardless of the service periods scheduled on the first link.

The invention also concerns a communication method in a wireless network, comprising, at an access point multi-link device, AP MLD, configured to carry out frame exchange operations with at least a given non-AP MLD operating in Enhanced Multi-Link, EML, mode that applies with a set of EML links:
scheduling, in beacon frames transmitted by the AP MLD on a first link of the EML links, service periods for the given non-AP MLD that do not overlap in time any beacon frames transmitted by the AP MLD over a second link of the EML links.

As a consequence, the scheduled service periods (e.g. rTWT SPs) are no longer an obstacle for the non-AP MLD to correctly receive the beacon frames.

The invention also concerns a communication method in a wireless network, comprising, at an access point multi-link device, AP MLD, configured to carry out frame exchange operations with non-AP MLDs operating in Enhanced Multi-Link, EML, mode that applies with a set of EML links:
transmitting an initial frame that triggers frame exchange sequences with at least one non-AP MLD operating in the EMLSR mode and at least one non-AP MLD operating in the EMLMR mode,
the AP MLD ensuring that the padding duration of a Padding field of the initial frame is greater than or equal to the maximum of the values indicated in an EMLSR Padding Delay subfield and an EMLMR Delay subfield received from the non-AP MLDs with which the frame exchange sequences are initiated.

Thus, the AP MLD can trigger both one or several non-AP MLD(s) operating in the EMLSR mode and one or several non-AP MLD(s) operating in the EMLMR mode, while ensuring that the padding duration indicated in the initial frame (IC frame in EMLSR mode and Initial frame in EMLMR mode) is enough to allow all these non-AP MLDs (both the one(s) operating in the EMLSR mode and the one(s) operating in the EMLMR mode) to switch the state of their affiliated stations from the listening operation state to the enabled/disabled frame exchange state.

Correlatively, the invention also provides a wireless communication device comprising at least one microprocessor configured for carrying out any method as described above.

Another aspect of the invention relates to a non-transitory computer-readable medium storing a program which, when executed by a microprocessor or computer system in a wireless device, causes the wireless device to perform any method as described above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions between EML-capable MLDs in which the present invention may be implemented;

FIGS. 1a and 1b illustrate an exemplary 802.11be multi-link reference model for a MLD either AP MLD or non-AP MLD;

FIG. 2 schematically illustrates an exemplary sequence of frames of the EMLSR Operating Mode as specified in D2.0 standard;

FIG. 3 illustrates a format of a Target Wake Time, TWT, element adapted to be used for r-TWT according to the D2.0 standard;

FIG. 4 illustrates, using a frames sequence, the EMLSR Operating Mode in a non-AP MLD that has negotiated an rTWT service on one of its EMLSR links with its AP MLD, according to a particular embodiment of the invention;

FIG. 5 illustrates, using a flowchart, steps performed by an EMLSR-active non-AP MLD according to embodiments of the invention;

FIG. 6a presents an enhanced frame exchange sequence with regards to TWT mechanisms support by EMLSR stations according to a first embodiment of the invention;

FIG. 6b presents an enhanced frame exchange sequence with regards to TWT mechanisms support by EMLSR stations according to a second embodiment of the invention;

FIG. 6c presents an enhanced frame exchange sequence with regards to TWT mechanisms support by EMLSR stations according to a third embodiment of the invention;

FIG. 7 illustrates, using a flowchart, steps performed by an EMLSR-active non-AP MLD when a TWT service is already setup before the EML operation is going to be activated;

FIG. 8 illustrates, using a flowchart, steps performed by an EMLSR-active non-AP MLD which intends to limit the use of TWT service over a given number of links;

FIG. 9 schematically illustrates an EMLSR capable architecture for an MLD to implement embodiments of the invention;

FIG. 9a schematically illustrates an EMLMR capable architecture for an MLD to implement embodiments of the invention; and

FIG. 10 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or STAs. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., STAs). In some aspects, a wireless device or STA implemented in accordance with the teachings herein may comprise an access point (so-called AP) or not (so-called non-AP STA or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP STA may comprise, be implemented as, or known as a subscriber STA, a subscriber unit, a mobile STA (MS), a remote STA, a remote terminal, a user terminal (UT), a user agent, a user device, user equipment (UE), a user STA, or some other terminology. In some implementations, a STA may comprise a cellular telephone, a cordless telephone, a Session Initiation Protocol (“SIP”) phone, a wireless local loop (“WLL”) STA, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA may be a wireless node. Such wireless node may provide, for example, connectivity for or to a network (e.g., a wide area network such as the Internet or a cellular network) via a wired or wireless communication link.

An AP manages a set of STAs (registered to it or associated with it) that together organize their accesses to the wireless medium for communication purposes. The STAs (including the AP to which they register) form a service set, here below referred to as basic service set, BSS (although other terminology can be used). A same physical STA acting as an access point may manage two or more BSS (and thus corresponding WLANs): each BSS is thus uniquely identified by a specific basic service set identification, BSSID and managed by a separate virtual AP implemented in the physical AP. Each STA is identified within a BSS thanks to an identifier, AID, assigned to it by the AP upon registration.

The 802.11 family of standards define various media access control (MAC) mechanisms to drive access to the wireless medium.

The current discussions in the task group 802.11be, as illustrated by draft IEEE P802.11be/D2.0 of May 2022, introduce the Multi-Link Operation (MLO) when it comes to MAC layer operation. The MLO allows multi-link devices to establish or setup multiple links and operate them simultaneously.

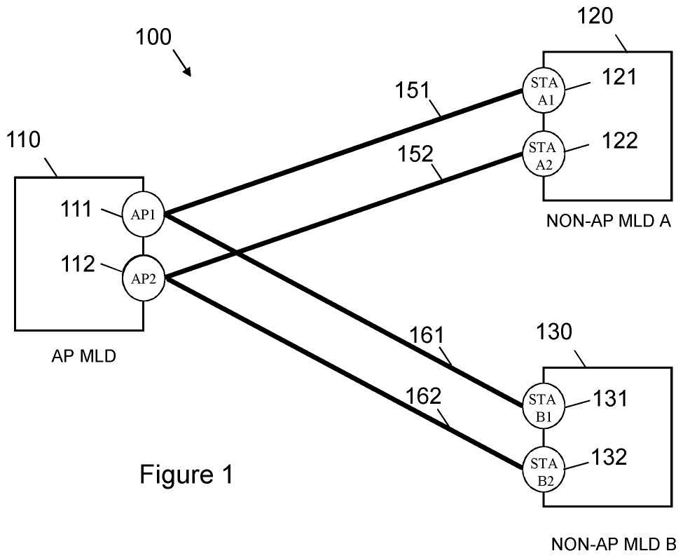

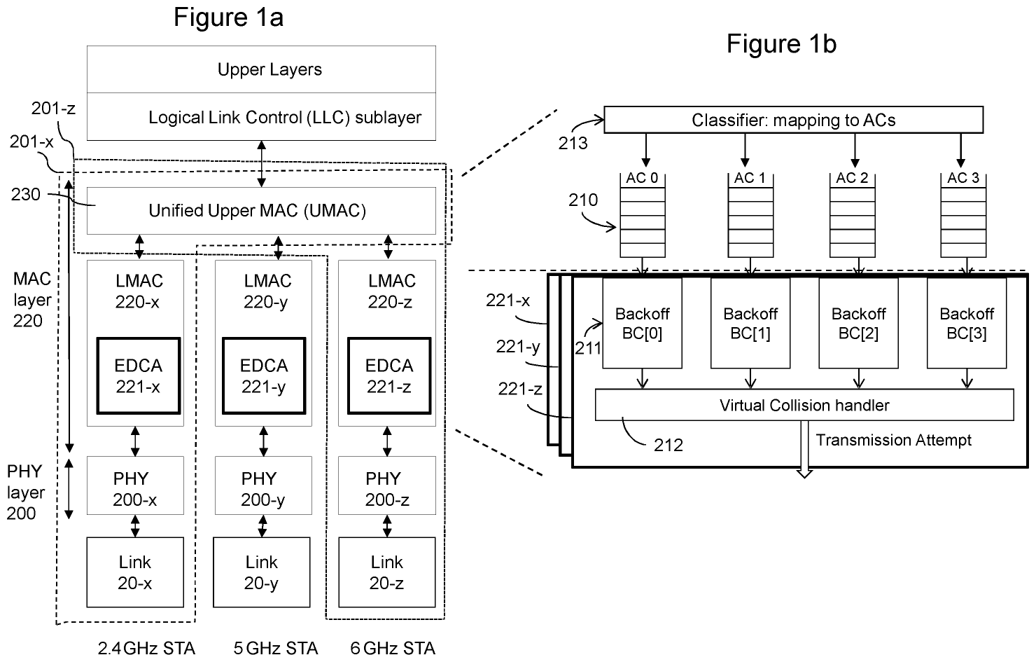

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as “affiliated AP”. A non-Access Point Multi-Link Device (or non-AP MLD) corresponds to a MLD where each STA affiliated with the MLD is a non-AP STA, referred to as “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device. An illustrative architecture of a Multi-Link Device is described below with reference to FIGS. 1a and 1b.

Multiple affiliated non-AP STAs of a non-AP MLD can then setup communication links with multiple affiliated APs of an AP MLD, hence forming a multi-link channel.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHZ, 40 MHZ, and so on) in a given frequency band (e.g. 2.4 GHZ, 5 GHZ, 6 GHZ) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated STAs but not necessary a number equal to its number of affiliated STAs. In particular, a non-AP MLD may operate with a number of affiliated STAs greater than its number of radios (which can even be reduced to a single one).

Several Enhanced Multi-Link Operating Modes (or EML OMs in short) have been defined by the D2.0 standard from this physical architecture, namely the Enhanced Multi-Link Single Radio (EMLSR) and the Enhanced Multi-Link Multi Radio (EMLMR). The D2.0 standard states that the two EMLSR and EMLMR modes are mutually exclusive.

Any non-AP MLD declares its support of the EMLSR and/or EMLMR mode (in its so-called EML Capabilities) to the AP MLD during the association phase. In operation mode, the activation and the deactivation of the EMLSR or EMLMR Mode is initiated by the non-AP MLD which sends a specific EHT action frame referred to as “EML OM Notification”, indicating in particular the set of enabled links (so-called EMLSR or EMLMR links) in which the EMLSR or EMLMR mode to activate is applied. Usually the set “EMLSR/EMLMR links” is made of two enabled links. However, a greater number of enabled links may be used.

The EMLSR mode, once activated, allows the non-AP MLD to simultaneously listen to the enabled links of the set “EMLSR links” to receive initial control frames (e.g. MU-RTS trigger frames or BSRP trigger frames) transmitted by the AP MLD and next to perform data frames exchange with the AP MLD over only one link at a time, usually the link over which the initial control frame is received. Each non-AP MLD may support or not the EMLSR operating mode.

In the EMLMR mode, a non-AP MLD is able to aggregate some physical resources of multiple radios dedicated to multiple enabled links (so-called EMLMR links), in order to transmit or receive data up to a pre-defined number of supported Rx/Tx spatial streams. This predefined number is higher than the number of supported Rx/Tx spatial streams per each radio, hence providing throughput enhancement and latency reduction. As an example, a multi-radio (MR) non-AP MLD supporting the EMLMR mode on two links (with associated radios) communicates over the two links using the two respective radios when the EMLMR mode is deactivated, for example in a 2×2 MIMO antenna configuration for each radio. On the other hand, the MR non-AP MLD communicates over one of the two links using one of its radios with the aggregated physical resources of the two radios (typically the antennas) when the EMLMR mode is activated, for example in a 4×4 MIMO antenna configuration. In the same time, the other link (deprived of its physical antenna) cannot be used.

The EMLMR mode, once activated, allows the non-AP MLD to simultaneously listen to the enabled links of the set “EMLMR links” to receive an initial frame transmitted by the AP MLD to initiate frame exchange and next to perform data frame exchange with the AP MLD over only one EMLMR link (aggregating the radio resources) at a time, usually the link over which the initial frame is received.

The description below mostly concentrates on the EMLSR mode for ease of explanation. However, similar considerations can be made with respect to the EMLMR mode.

FIG. 1 illustrates a typical 802.11 network environment involving ML transmissions between EML-capable MLDs (EMLSR and or EMLMR capable) in which the present invention may be implemented.

Wireless communication network 100 involves an AP MLD 110 and two non-AP MLDs 120 and 130. In the example, the two non-AP MLDs are considered to be EML capable and have declared their corresponding capabilities to the AP MLD 110, within the EMLSR-related fields and EMLMR-related fields of the EML Capabilities (these fields are referred to below as EMLSR Capabilities and EMLMR Capabilities, i.e. subparts of the EML Capabilities). Of course, another number of non-AP MLDs registering to the AP MLD 110 and then exchanging frames with it may be contemplated, as well as another (greater) number of EML-capable non-AP MLDs.

AP MLD 110 has multiple affiliated APs, two affiliated APs 111 and 112 (also referenced AP1, AP2 respectively) in the exemplary FIG. 1, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP STAs, each of which behaves as an 802.11 non-AP STA in a BSS (managed by an affiliated AP 111 or 112) to which it registers. In the exemplary FIG. 1, two non-AP STAs 121 and 122 (also referenced A1 and A2 respectively) are affiliated with non-AP MLD 120 and two non-AP STAs 131 and 132 (also referenced B1 and B2 respectively) are affiliated with non-AP MLD 130.

For illustrative purposes, non-AP MLDs 120 and 130 are single-radio non-AP MLDs. For example, AP 111 is set to operate on channel 38 corresponding to an operating 40 MHz channel in the 5 GHz frequency band and AP 112 is set to operate on channel 151 corresponding to another operating 40 MHz channel in the 5 GHz frequency band too. In another example, the affiliated STAs could operate on different frequency bands.

Each affiliated AP offers a link towards the AP MLD 110 to the affiliated non-AP STAs of a non-AP MLD (120 or 130). Hence, the links for each non-AP MLD can be merely identified with the identifiers of the respective affiliated APs. In this context, each of the affiliated APs 111 and 112 can be identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP STA of the non-AP MLD. Each of such links, referred to as “enabled link” enables individual channel access and frame exchanges between the non-AP MLD and the AP MLD based on supported capabilities exchanged during association.

The discovery phase is referred below to as ML discovery procedure, and the multi-link setup phase (or association phase) is referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate setup links between its own affiliated non-AP STAs and some of the discovered affiliated APs and to request the AP MLD 110 to set up these links, which may be accepted or refused by the AP MLD. If the AP MLD accepts, the non-AP MLD is provided with an Association Identifier (AID) by the AP MLD, which AID is used by the affiliated non-APs of the non-AP MLD to wirelessly communicate over the multiple links (communication channels) with their corresponding affiliated APs. During the ML setup procedure, the non-AP MLDs declare part or all of their capabilities. For instance, they may declare their EMLSR capability. For this, appropriate fields are provided in the management frames. In particular, some of the management frames exchanged during the ML discovery and ML setup procedures contains a new Information Elements specific to the Multi-Link Operation (MLO), referred to as Basic Multi-Link element. De facto, in all Management frames that include a Basic Multi-Link element except Authentication frames, a non-AP or AP MLD which is EMLSR capable (dot11EHTEMLSROptionImplemented equal to true) or EMLMR capable (dot11EHTEMLMROptionImplemented equal to true) sets, in the EML Capabilities subfield of the Common Info field, the EMLSR or EMLMR Support bit to 1.

For illustrative purpose, in wireless communication network 100, during the ML setup procedures, two candidate setup links have been requested by non-AP MLD 120 and accepted by AP MLD 110: a first link 151 between affiliated AP 111 (AP1) and affiliated non-AP STA 121 (A1), a second link 152 between affiliated AP 112 (AP2) and affiliated non-AP STA 122 (A2). Similarly, two candidate setup links have been requested by multi-radio non-AP MLD 130 and accepted by AP MLD 110: a first link 161 between affiliated AP 111 (AP1) and affiliated non-AP STA 131 (B1), a second link 162 between affiliated AP 112 (AP2) and affiliated non-AP STA 132 (B2).

AP MLD 110, non-AP MLD 120 and non-AP MLD 130 are considered as EMLSR capable (dot11EHTEMLSROptionImplemented equal to true) or EMLMR capable (dot11EHTEMLMROptionImplemented equal to true). They exchange their EMLSR or EMLMR capabilities (subparts of the EML Capabilities) during their ML discovery procedure and the multi-link setup phase.

As currently defined in the D2.0 Standard, the EMLSR and EMLMR Capabilities include the following subfields:
the “EMLSR Support” subfield indicating support of the EMLSR operation for the MLD. The EMLSR Support subfield is set to 1 if the MLD supports the EMLSR operation; otherwise it is set to 0;
the “EMLSR Padding Delay” 3-bit subfield indicating the minimum MAC padding duration of the Padding field of the initial Control frame requested by the non-AP MLD as defined in the Enhanced multi-link single radio operation (section 35.3.17). A table converts the 3-bit values into padding delays in μs. This delay is used to define the transition period needed by the MLD to switch the state of its affiliated stations from the listening operation state to the enable/disable frame exchange states. This transition period is made of this delay added to the time length of an Initial Control frame response as described below. This transition period is therefore referred to as “EMLSR active switch delay”;
the “EMLSR Transition Delay” 3-bit subfield indicating the transition delay time needed by a non-AP MLD to switch from so-called frame exchange modes (on one of the enabled links) to the so-called listening operation mode on the enabled links. A table converts the 3-bit values into delays in μs. For instance, it is set to 0 for 0 μs, set to 1 for 16 μs, 2 for 32 μs, set to 3 for 64 μs, set to 4 for 128 μs, set to 5 for 256 μs, and the values 6 to 7 are reserved;
the “EMLMR Support” subfield indicating support of the EMLMR operation for the MLD. The EMLMR Support subfield is set to 1 if the MLD supports the EMLMR operation; otherwise it is set to 0;
the “EMLMR Delay” 3-bit subfield indicating the minimum padding duration required for a non-AP MLD for EMLMR link switch when operating in the EMLMR mode. This delay is used to define the transition periods needed by the MLD to switch the state of its affiliated stations when starting or ending a frame exchange. The transition period for the start of a frame exchange is made of this delay (EMLMR delay) added to the time length of an Initial frame response as described below. This start transition period is therefore referred to as “EMLMR active switch delay” below.
the “Transition Timeout” subfield indicating the timeout value for EML Operating Mode Notification frame exchange in EMLSR (or EMLMR).

When a non-AP MLD which is EMLSR (resp. EMLMR) capable intends to operate in the corresponding mode on a set of enabled links, referred to as EMLSR (resp. EMLMR) links, a STA affiliated with the non-AP MLD transmits an EML Operating Mode (OM) Notification frame (specified in D2.0 standard) with the EMLSR (resp. EMLMR) Mode subfield of the EML Control field set to 1 to an AP affiliated with an AP MLD which is EMLSR (resp. EMLMR) capable (here AP MLD 110). The EMLSR (resp. EMLMR) links are indicated in the EMLSR (resp. EMLMR) Link Bitmap subfield of the EML Control field of the EML OM Notification frame by setting the bit positions of the EMLSR (resp. EMLMR) Link Bitmap subfield to 1 for each of the EMLSR (resp. EMLMR) links. For example, in the EMLSR (resp. EMLMR) Bitmap, the bit position i corresponds to the link with the Link ID equal to i and is set to 1 to indicate that the link is a member of the EMLSR (resp. EMLMR) links.

The AP affiliated with the AP MLD that received the EML Operating Mode Notification frame from the STA affiliated with the non-AP MLD next transmits an EML Operating Mode Notification frame to one of the STAs affiliated with the non-AP MLD within the timeout interval indicated in the Transition Timeout subfield in the EML Capabilities subfield of the Basic Multi-Link element starting at the end of the PPDU transmitted by the AP affiliated with the AP MLD as an acknowledgement to the EML Operating Mode Notification frame transmitted by the STA affiliated with the non-AP MLD.

After the successful transmission of the EML Operating Mode Notification frame on one of the EMLSR (resp. EMLMR) links by the STA affiliated with the non-AP MLD, the non-AP MLD operates in the EMLSR (resp. EMLMR) mode, it is considered as EMLSR-active (resp. EMLMR-active).

When a non-AP MLD which is EMLSR capable intends to disable the EMLSR (resp. EMLMR) mode, a STA affiliated with the non-AP MLD transmits an EML Operating Mode (OM) Notification frame (specified in D2.0 standard) with the EMLSR (resp. EMLMR) Mode subfield of the EML Control field set to 0 to an AP affiliated with the AP MLD. Again, an AP affiliated with the AP MLD that received the EML Operating Mode Notification frame from the STA affiliated with the non-AP MLD transmits an EML Operating Mode Notification frame as above as an acknowledgement to the EML Operating Mode Notification frame. After the successful transmission of the EML Operating Mode Notification frame on one of the EMLSR (resp. EMLMR) links by the STA affiliated with the non-AP MLD, the non-AP MLD disables the EMLSR (resp. EMLMR) mode.

The set of STAs affiliated with an EMLSR (resp. EMLMR) capable non-AP MLD operating on the EMLSR (resp. EMLMR) links may be all or part of the STAs affiliated with the non-AP MLD. The STAs of this set are referred below to “EMLSR co-affiliated STAs” (resp. EMLMR co-affiliated STAs) for the non-AP MLD.

In the example of FIG. 1, the EMLSR co-affiliated STAs of non-AP MLD 120 and of non-AP MLD 130 operate on the same links (i.e. with the same affiliated APs, AP1 and AP2) meaning they share the same EMLSR links.

FIG. 1a illustrates an exemplary 802.11be multi-link reference model for a MLD either AP MLD or non-AP MLD.

The MLD comprises a PHY layer 200, a MAC layer 220, a logical link control (LLC) sublayer and upper layers.

Upper layers may include applications that generate traffic data or use received traffic data.

The transmission and the reception of the traffic data are handled by the MAC 220 and PHY 200 layers. Such transmission and the reception of the traffic data may take place over multiple links 20-x, 20-y, 20-z, as the ones 151, 152, 161, 162 introduced with reference to FIG. 1. Three links and therefore three affiliated stations are shown. Of course, other configurations including two affiliated stations or more than three affiliated stations may be contemplated.

The traffic data are provided by the upper layers as a sequence of data frames, or “traffic stream”. Each traffic stream and thus each data frame are associated with an access category (AC) as defined in the EDCA mechanism (FIG. 1b). This mapping between the streams or data frames and the ACs is made by a classifier 213.

It is recalled that an 802.11 station (AP and non-AP station) maintains four Access Categories (ACs), each having one or more corresponding transmit buffers or queues. The four ACs are conventionally defined as follows:
AC1 and AC0 are reserved for best effort and background traffic. They have, respectively, the penultimate lowest priority and the lowest priority.
AC3 and AC2 are usually reserved for real-time applications (e.g., voice or video transmission). They have, respectively, the highest priority and the penultimate highest priority.

The data frames, also known as MAC service data units (MSDUs), incoming from an upper layer of the protocol stack are mapped, by classifier 213, onto one of the four ACs and thus input in a queue of the mapped AC.

FIG. 1b illustrates an implementation model with four transmit queues, one per access category.

The 802.11be multi-link reference model reflects the fact that MLDs may transmit and receive using several links, particularly at the level of the MAC layer 220 and the PHY layer 200.

The MAC layer 220 comprises one Unified Upper-MAC (UMAC) layer 230, multiple Lower-MAC (LMAC) layers 220-x, 220-y, 220-z coupled with a respective PHY layer 200-x, 200-y, 200-z, each couple corresponding to a link 20-x, 20-y, 20-z.

The UMAC 230 performs functionalities that are common across all links and each LMAC 220-x, 220-y, 220-z performs functionalities that are local to each link 20-x, 20-y, 20-z. The UMAC layer then offers a UMAC interface with the link-specific blocks 220-x, 220-y, 220-z and also provides a UMAC Service Access Point (SAP) to the LLC and upper layers.

The UMAC 230 is responsible for link-agnostic MAC procedures such as authentication, association, security association, sequence number assignments, MAC Protocol Data Unit (MPDU) encryption/decryption, aggregation/de-aggregation, acknowledgement score boarding procedure, etc.

Each data unit, MSDU, arriving at the MAC layer 220 from an upper layer (e.g. Link layer) with a type of traffic (User Priority (UP) hence Traffic Identifier (TID)) priority is mapped onto one of the ACs according to the mapping rule at the UMAC layer 230. Then, still at the UMAC layer 230, the data unit, MSDU, is provided with the next sequence number available and is stored in the queue corresponding to its TID (or UP) within the mapped AC.

Each LMAC 220-x, 220-y, 220-z is in charge of link specific functionalities like the channel access. In particular, each MLD Lower MAC includes its own contention-based channel access procedure, e.g. EDCA 221-x, 221-y, 221-z. Some of the functionalities require joint processing of both the UMAC 230 and LMACs 220-x, 220-y, 220-z.

As illustrated in FIGS. 1a and 1b, each EDCA 221-x, 221-y, 221-z per link performs contention per link for each queue. In that respect, each AC has its own set of queue contention parameters per link, and is associated with a priority value, hence defining traffics of higher or lower priority of MSDUs. Thus, there is a plurality of traffic queues for serving data traffic at different priorities for a given link. The contention window CW and the backoff value are known as being EDCA variables, and are specialized for each link 20-x, 20-y, 20-z.

That means that each AC acts as an independent DCF contending entity on a given link, including its respective queue backoff engine 211. Thus, each queue backoff engine 211 is associated with a respective traffic queue 210 for using queue contention parameters and drawing a backoff value (from CW) to initialize a respective queue backoff counter specialized per AC and per link. The backoff counter is used to contend for access to the link 20-x, 20-y, 20-z in order to transmit data stored in the queue of the AC. Practically, the backoff counter is decremented from its initialization value when the medium is idle, and the corresponding affiliated STA 201-x, 201-z is allowed to transmit (access granted) when the backoff counter reaches 0.

When the access to the wireless medium is granted for an AC on a link, MSDUs stored for that AC are transmitted to the physical (PHY) layer 200-x, 200-y, 200-z for transmission over the link.

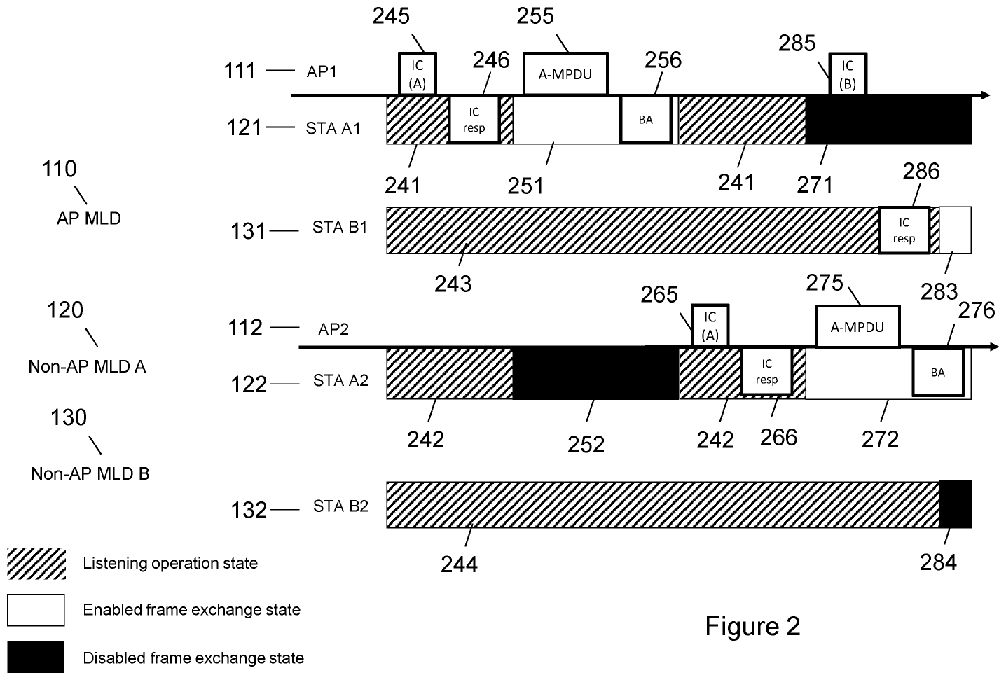

FIG. 2 illustrates, using a frames sequence, the EMLSR Operating Mode in non-AP MLD 120 when AP MLD 110 decides to use the EMLSR mode. Of course, although the EMLSR mode is emphasized here by way of example, similar considerations can be made with respect to the EMLMR mode.

In this sequence, the non-AP MLDs operate in the EMLSR mode, meaning EML Operating Mode Notification frames activating the EMLSR mode have been successfully transmitted by affiliated STAs of the non-AP MLD 120. In other words, it has entered an active Enhanced Multi-Link Single Radio, EMLSR, mode applying to a specific set of two or more enabled links.

The affiliated STAs 121 and 122 are EMLSR co-affiliated STAs within non-AP MLD 120. Each affiliated STA can be in one of three defined states: listening operation state, enabled frame exchange state and disabled frame exchange state.

Non-AP MLD 120 is able to listen simultaneously on its EMLSR links, by having its EMLSR co-affiliated STA(s) corresponding to those links in “awake” or “listening operation” state. For example, affiliated STAs A1, A2 are in the listening operation state (referenced 241 and 242). The listening operation includes CCA (Clear Channel Assessment) and receiving an initial Control frame of frame exchanges that is initiated by the AP MLD. In non-AP MLD 120, the two EMLSR co-affiliated STAs therefore simultaneously listen for receiving the initial Control frame from the AP MLD.

When the AP MLD 110 intends to initiate frame exchanges with one or more non-AP MLDs on one of the EMLSR links, it begins the frame exchanges by transmitting the initial Control frame 245 which explicitly triggers the non-AP MLD. To a certain extent, the initial Control frame schedules the non-AP MLD. The initial Control frame of frame exchanges is sent in the OFDM PPDU or non-HT duplicate PPDU format using a rate of 6 Mbps, 12 Mbps, or 24 Mbps (i.e. MCS subfield in the frame set to a value up to 2). As defined in the D2.0 Standard, the initial Control frame shall be a MU-RTS Trigger frame or a BSRP Trigger frame as defined in IEEE Std 802.11ax™-2021. Given the trigger frame format according to which such a frame includes one or more User Info fields, this condition means frame 245 includes a User Info field addressed to the non-AP MLD, i.e. where an AID12 field is set to the AID of the non-AP MLD (obtained upon registration).

In the present example and as shown by reference “IC (A)”, the initial Control frame 245 explicitly triggers non-AP MLD A 120. The initial Control frame may explicitly trigger multiple non-AP MLDs using multiple User Info fields therein.

The EMLSR co-affiliated STA of the non-AP MLD explicitly triggered by the initial Control frame 245 that receives the frame, e.g. affiliated STA A1 in the example, initiates a state change of the EMLSR co-affiliated STA of the non-AP MLD considered, e.g. a change of the states of affiliated STAs A1 and A2 in the example, and sends an Initial Control frame response (IC resp.) 246 to the AP AP1 affiliated with the AP MLD 110.

After receiving the initial Control frame of frame exchanges 245 and transmitting an immediate response frame 246 as a response to the initial Control frame, the STA affiliated with the non-AP MLD that was listening on the corresponding link, i.e. the receiving EMLSR co-affiliated STA A1 in the example, is configured to be able to transmit or receive frames on the enabled link in which the initial Control frame 245 was received, i.e. link 151 in the example. To do so, a state switching procedure is invoked which results in having the receiving EMLSR co-affiliated STA being switched, after an EMLSR active switch delay, from the listening operation state 241 to an “active frame exchange” or “enabled frame exchange” state, referenced 251 in the Figure. The receiving EMLSR co-affiliated STA in this new state is capable of receiving a PPDU that is sent using more than one spatial stream on the link in which the initial Control frame 245 was received. The EMLSR active switch delay corresponds to the delay time needed by a non-AP MLD to switch from the EMLSR listening operation mode to the EMLSR frame exchange mode. As mentioned above, it is specified in the EML Capabilities (through the EMLSR Padding Delay) exchanged with the AP MLD.

Simultaneously, the other EMLSR co-affiliated STAs of the same non-AP MLD, i.e. STA A2 in the example, are configured not to transmit or receive on the other EMLSR link(s) until the end of the frame exchanges. To do so, a state switching procedure is also invoked for the other EMLSR co-affiliated STAs which in turn are switched from the listening operation state 242 to a “blindness frame” or “disabled frame exchange” state, referenced 252 in the Figure. In particular, no data is transmitted by the AP MLD intended to these other EMLSR co-affiliated STAs.

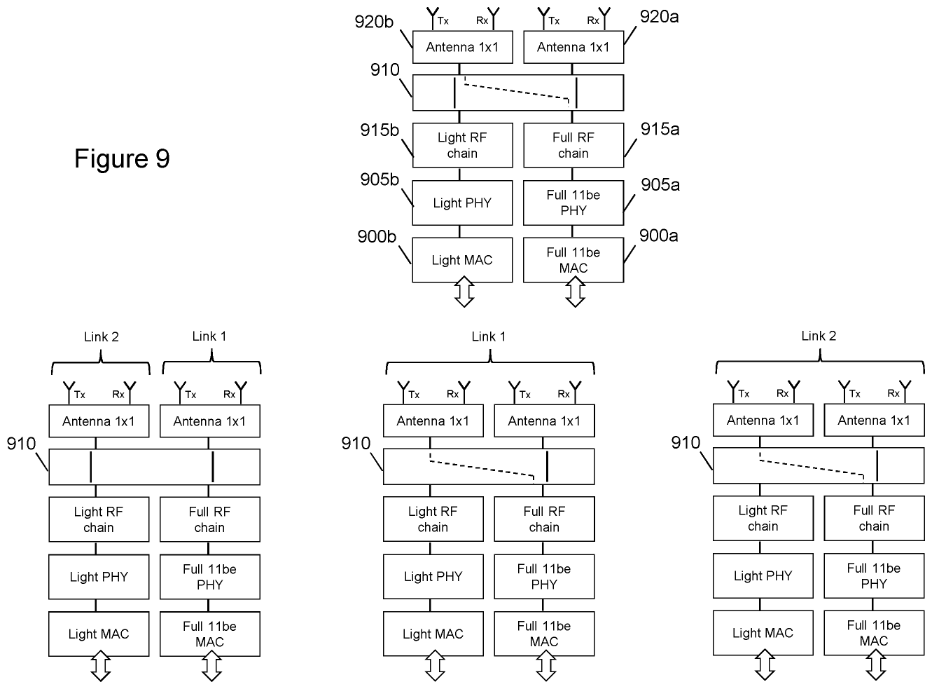

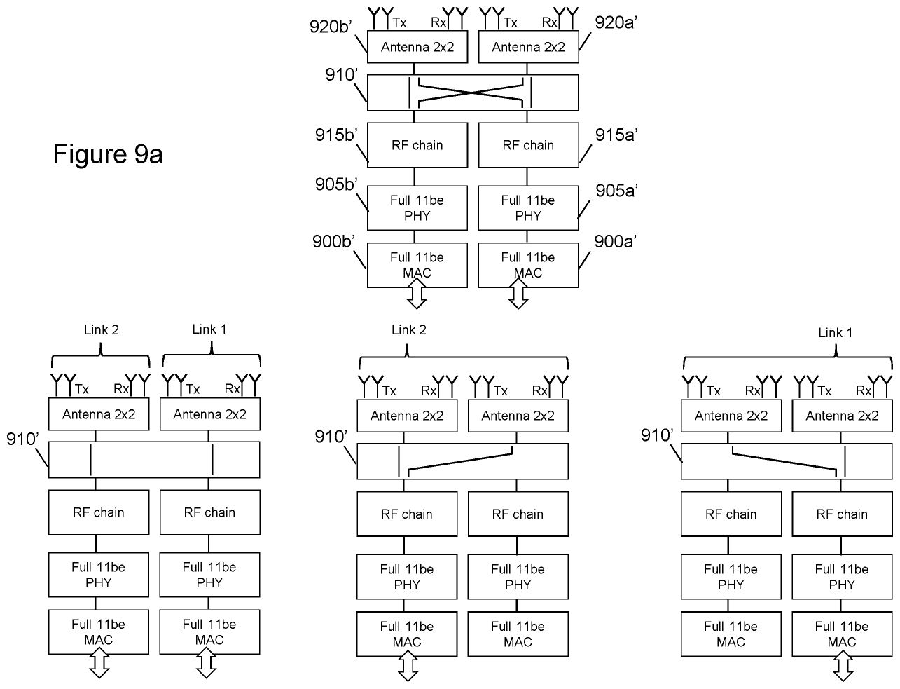

The state switches of all the EMLSR co-affiliated STAs within the same non-AP MLD are inseparable, hence simultaneous, because it is a question of allocating a full radio resource chain (see FIG. 9 below) to one of the STAs while the others are deprived of such chain. With respect to the EMLMR mode, the physical resources (e.g. antennas) of one radio resource chain are allocated (and aggregated) to the other radio resource chain, the former being therefore deprived of transmission/reception capabilities (see FIG. 9a below).

The above shows that when a non-AP MLD operates in the EMLSR mode (and more generally in any of the EMLSR and EMLMR modes), it is either in a listening operation mode (its co-affiliated STAs are in the listening operation state) or in a frame exchange mode (one of its co-affiliated STAs is in the enabled frame exchange state while the other co-affiliated STAs are in the disabled frame exchange state).

The simultaneous state change is required because, in the EMLSR mode, a single full radio resource is available that is assigned to the receiving EMLSR co-affiliated STA only, as explained below with reference to FIG. 9, while in the EMLMR mode, the antenna resources of one of the radio stack are assigned to the other radio stack as explained below with reference to FIG. 9a.

It turns out that only one of the EMLSR co-affiliated STAs of an explicitly triggered non-AP MLD can perform data frames exchange at a time with the AP MLD; this is usually the EMLSR co-affiliated STAs which received the initial Control frame 245.

An exemplary frame exchange sequence is shown in FIG. 2 that includes the sending of an A-MPDU frame 255 (hence downlink transmission) by the affiliated AP AP1 to the EMLSR co-affiliated STA A1 of explicitly triggered non-AP MLD A 120, followed by a corresponding block acknowledgment 256 from the latter.

After the end of the frame exchanges operated by the receiving EMLSR co-affiliated STA plus an EMLSR Transition Delay as specified in the EML capabilities, the non-AP MLD 120 switches back to the EMLSR listening operation state, meaning that the receiving EMLSR co-affiliated STA A1 switches back to the listening operation state 241 as well as the other EMLSR co-affiliated STA A2 (listening operation state 242). A state switching procedure is therefore invoked for each of the EMLSR co-affiliated STAs.

An end of frame exchanges can be sensed by a non-AP MLD, here non-AP MLD 120, if one of the following conditions is met:
(1) The MAC of the STA affiliated with the non-AP MLD that received the initial Control frame 245 does not receive a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement. This represents the end of an actual exchange with the AP MLD, without receiving a subsequent frame from the latter.
(2) The MAC of the STA affiliated with the non-AP MLD that received the initial Control frame 245 receives a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement, and the STA affiliated with the non-AP MLD does not detect, within the PPDU corresponding to the PHY-RXSTART.indication any of the following frames:
   an individually addressed frame with the RA equal to the MAC address of the STA affiliated with the non-AP MLD,
   a Trigger frame that has one of the User Info fields addressed to the STA affiliated with the non-AP MLD,
   a CTS-to-self frame with the RA equal to the MAC address of the AP affiliated with the AP MLD,
   a Multi-STA BlockAck frame that has one of the Per AID TID Info fields addressed to the STA affiliated with the non-AP MLD,
   a NDP Announcement frame that has one of the STA Info fields addressed to the STA affiliated with the non-AP MLD.

This corresponds to the case where, after an actual exchange with the AP MLD, the non-AP MLD receives another frame from the AP MLD which is not addressed to it (i.e. no data is addressed to it or no resource is allocated to it).
(3) The STA affiliated with the non-AP MLD that received the initial Control frame 245 does not respond to the most recently received frame (e.g. A-MPDU frame 255) from the AP affiliated with the AP MLD that requires immediate response after a SIFS.

As non-AP MLD 120 is now in the EMLSR listening operation mode, the AP MLD may initiate any new frame exchange sequence (with either of non-AP MLD 120 or 130) by transmitting a new initial Control frame.

In the example of the Figure, the AP MLD 110 decides to initiate such a new sequence with non-AP MLD 120 again, using its EMLSR co-affiliated STA A2 122. In details, the AP MLD 110 using its other affiliated AP 112 transmits a new Initial Control frame 265 IC (A) explicitly triggering the non-AP MLD A 120, which frame is now received by the EMLSR co-affiliated STA A2 122. The receiving EMLSR co-affiliated STA A2 122 transmits a response frame 266 to the Initial Control frame 265. After an EMLSR active switch delay, the explicitly triggered non-AP MLD 120 switches to EMLSR frame exchange mode where the receiving EMLSR co-affiliated STA A2 122 switches from the listening operation state 242 to the enabled frame exchange state 272 while its other EMLSR co-affiliated STA A1 121 simultaneously switches from the listening operation state 241 to the disabled frame exchange state 271. Frames 275, 276 are then exchanged during the frame exchange sequence, up to the end of the sequence where the non-AP MLD 120 switches back to the EMLSR listening operation mode.

A-MPDU 255/275 is only provided as an illustration. Other types of frames can be sent by the AP MLD, e.g. basic Trigger frames to trigger UL transmissions. Although FIG. 2 shows frame exchanges made of a single frame 255/275 followed by an acknowledgment 256/276, simpler frame exchanges may only comprise a single frame sent by the AP MLD without acknowledgment, while more complex frame exchanges may comprise multiple sequences of exchanges, e.g. cascaded TXOPs (Transmit Opportunities) for UL transmissions (triggered by a basic Trigger frame) and/or for DL transmissions (through an HE MU PPDU).

This illustrative example shows the advantages of the EMLSR mode in terms of throughput and latency: the AP MLD may switch quickly from one link to another link, hence improving communication performances for a limited increase of complexity and cost.

In this example, the AP MLD 110 initiates the sequence of frame exchange with one or more designated non-AP MLDs. The D2.0 standard also allows the non-AP MLDs to initiate a sequence of frame exchange with the AP MLD. In other words, a STA affiliated with a non-AP MLD operating in the EMLSR mode does not need to transmit an initial Control frame to initiate frame exchanges with the AP MLD. Such affiliated STA follows the rules defined in sections 10.3.2.4 (to set and reset the NAV) and 10.23.2 (HCF contention based channel access (EDCA)) to access the wireless medium.

However, conventional medium access mechanisms (e.g. TWT or rTWT as described below) are not defined with respect to the particularities of EMLSR-active MLDs, in particular regarding the states of their co-affiliated STAs. It is recalled that an EMLSR-capable non-AP MLD becomes EMLSR-active following a successfully exchange of an EML OM Notification frame with the EMLSR-capable AP MLD, in which frame the EMLSR Mode subfield of the EML Control field is set to 1 and the EMLSR links are specified, hence the corresponding EMLSR co-affiliated STAs.

As mentioned above, the preceding description also applies to the EMLMR mode with, inter alia, the following matchings in an implementation: the EMLMR Delay applies for both EMLSR Padding Delay and EMLSR Transition Delay; the initial frame in the EMLMR mode matches the initial control frame in the EMLSR mode and similarly the initial frame response in the EMLMR mode matches the initial control frame response in the EMLSR mode; although not defined in the D2.0 Standard, an EMLMR listening operation state/mode can be defined that matches the EMLSR listening operation state/mode where the co-affiliated STAs are listening to their links before aggregation of physical radio resources.

More generally, according to implementations of the invention, the following delays are defined for specifying timings for EML switching operations. The standard is deficient in providing guidance on these timings. Some subfields of the EML Capabilities subfield in the Common Info field of the Basic Multi-Link element as specified in the standard are reused for newly defined delays.

### “EML Active Switch Delay”

“EML active switch delay” is defined as the transition period needed by the non-AP MLD to switch the state of its affiliated stations from awake or listening operation state to the enable or disable frame exchange state. The EML active switch delay ensures that the non-AP MLD has completed its switching operation prior the frame exchange triggered by the AP MLD.

The delay is referred to as “EMLSR active switch delay” in case of EMLSR operation and “EMLMR active switch delay” in case of EMLMR operation.

In an implementation of the EMLSR active switch delay,

EMLSR active switch delay=EMLSR Padding Delay+aSIFSTime+Transmission time of Initial Control Response frame; where:

“EMLSR Padding Delay” is the 3-bit subfield of the EML Capabilities subfield in the Common Info field of the Basic Multi-Link element;

“aSIFSTime” is the nominal time (in microseconds) that the MAC and PHY require from reception of the end of a PPDU, until the MAC and PHY have processed any frame(s) therein, and responded with the start of the PPDU containing the earliest possible response frame; and

“Transmission time of Initial Control Response frame” is the duration of the shortest initial control response frame used on EMLSR links upon which the EMLSR Padding Delay has been determined by the non-AP MLD.

In an implementation of the EMLMR active switch delay,

EMLMR active switch delay=EMLMR Delay+aSIFSTime+Transmission time of Initial Response frame; where:

“EMLMR Delay” is the 3-bit subfield of the EML Capabilities subfield in the Common Info field of the Basic Multi-Link element; and

“Transmission time of Initial Response frame” is the duration of the shortest initial response frame used on EMLMR links upon which the EMLMR delay has been determined by the non-AP MLD.

### “EML Transition Delay” (or “EML De-Active Switch Delay”)

“EML transition delay” is defined as the transition period needed by the non-AP MLD to switch the state of its affiliated stations from an enable or disable frame exchange state to awake or listening operation state. The EML transition delay is useful for the AP MLD to determine when the non-AP MLD is ready to receive a subsequent initial (control) frame on any one of the EML links.

The delay is referred to as “EMLSR transition delay” in case of EMLSR operation and “EMLMR transition delay” in case of EMLMR operation.

In an implementation, the EMLSR transition delay is “EMLSR transition delay” 3-bit subfield of the EML Capabilities subfield.

In an implementation, the EMLMR transition delay is “EMLMR Delay” 3-bit subfield of the EML Capabilities subfield.

In another implementation, the EMLMR transition delay is determined as follows:

EMLMR transition delay=EMLMR delay+aSIFSTime+Transmission time of Initial Response frame; where:
“EMLMR delay” is the 3-bit subfield of the EML Capabilities subfield; and
“Transmission time of Initial Response frame” is the duration of the shortest initial response frame used on EMLMR links estimated by the AP MLD.

The duration of Initial response frame can be different depending on the Initial frame. The AP MLD may estimate the duration of the shortest initial response frame used on EMLMR links (e.g., a CTS frame in non-HT PPDU with the highest rate in the BSSBasicRateSet parameters).

For a non-AP MLD in EMLSR mode, the time duration for switching from a awake/listening operation to a frame exchange operation (EMLSR active switch delay) and the time duration for switching back from the frame exchange operation to the awake/listening operation (EMLSR transition or de-active switch delay) may be different or equal.

For a non-AP MLD in EMLMR mode, the time duration for switching from a awake/listening operation to a frame exchange operation (EMLMR active switch delay) and the time duration for switching back from the frame exchange operation to the awake/listening operation (EMLMR transition or de-active switch delay) may be different or equal.

The non-AP MLD may determine the value of the EMLMR Delay subfield such that it satisfies the constraints related to both the EMLMR active switch delay and the EMLMR transition delay (e.g. the EMLMR Delay may correspond to the maximum value among the minimum allowed values of the EMLMR active switch and the EMLMR transition delays).

Reference is made to exemplary frame exchange sequence shown in FIG. 2 for describing EMLMR operations according to embodiments of the invention.

Within a TXOP initiated by an AP affiliated with AP MLD with an EMLMR STA affiliated with a non-AP MLD as the TXOP responder, the non-AP MLD switches to its per-link spatial stream capabilities defined by EHT Capabilities element or the latest OM (if exists) after an EMLMR Transition Delay (e.g., as discussed above, the “EMLMR delay” or “EMLMR delay+aSIFSTime+Transmission time of Initial Response frame”) if any of the following conditions is met and this is defined as the end of the frame exchange sequence:
The MAC of the STA affiliated with the non-AP MLD that received the initial frame 245 does not receive a PHY-RXSTART.indication primitive during a timeout interval of aSIFSTime+aSlotTime+aRxPHYStartDelay starting at the end of the PPDU (e.g. acknowledgment 256) transmitted by the STA affiliated with the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement.
The MAC of the STA affiliated with the non-AP MLD that received the initial frame 245 receives a PHY-RXSTART.indication primitive during a timeout interval of aSIFSTime+aSlotTime+aRxPHYStartDelay starting at the end of the PPDU (e.g. acknowledgment 256) transmitted by the STA affiliated with the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement and the STA affiliated with the non-AP MLD does not detect, within the PPDU corresponding to the PHY-RXSTARTindication any of the following frames:
   an individually addressed frame with the RA equal to the MAC address of the STA affiliated with the non-AP MLD
   a Trigger frame that has one of the User Info fields addressed to the STA affiliated with the non-AP MLD
   a CTS-to-self frame with the RA equal to the MAC address of the AP affiliated with the AP MLD
   a Multi-STA BlockAck frame that has one of the Per AID TID Info fields addressed to the STA affiliated with the non-AP MLD
   a NDP Announcement frame that has one of the STA Info fields addressed to the STA affiliated with the non-AP MLD and a sounding NDP
The STA affiliated with the non-AP MLD that received the initial frame 245 does not respond to the most recently received frame (e.g. A-MPDU frame 255) from the AP affiliated with the AP MLD that requires immediate response after a SIFS.

In the above paragraph, EMLMR STA refers to a non-AP STA affiliated with the non-AP MLD that is on an EMLMR link and OM refers to Operation Mode indication.

To meet low latency requirements in EHT as well as to increase efficiency of the UL MU operation, existing mechanisms have been reused within the D2.0 standard and improved, while other new mechanisms have been added.

The Stream Classification Service (SCS) mechanism, originally defined in the IEEE 802.11aa standard, has been adapted to be included in the D2.0 standard. The SCS mechanism for multi-link now allows a non-AP MLD to define and advertise the AP MLD of a (latency sensitive) traffic stream identified with an SCS identifier, SCSID. An adaptation of the SCS mechanism allows QoS requirements to be defined for the SCS stream through so-called QoS Characteristics element, in particular to classify the SCS stream as belonging to a TID class for a corresponding uplink (UL) or downlink (DL) direction.

The Target Wake Time (TWT) mechanism, originally defined in the IEEE 802.11ah and 802.11ax standards, has been adapted to be included in the D2.0 standard. An adaptation is known as the Restricted Target Wake Time (rTWT) which schedules dedicated (and protected) service periods (SPs) for stations (affiliated with a non-AP MLD) to convey their latency sensitive traffic(s), e.g. SCS streams, over their BSS. An rTWT agreement is nothing more than a Broadcast TWT agreement negotiated between an AP and an associated non-AP station of the BSS of a given link. The non-AP station establishes with the AP membership in a Broadcast TWT (or rTWT) schedule. The schedule may be defined for some TIDs (i.e. QoS characteristics as specified through the SCS mechanism). The rTWT Service Periods SPs of the rTWT schedule, in which SPs the protected exchanges of SCS traffic streams may take place, are advertised in broadcast management frames (e.g. beacons), using an rTWT information about the negotiated rTWT SPs, typically a Broadcast TWT ID (bTWT ID).

While the SCS mechanism is negotiated between an initiator non-AP MLD and the AP MLD, there are still mechanisms like TWT or rTWT that are negotiated per link, that is to say between an initiator affiliated STA of the non-AP MLD and the corresponding affiliated AP of the AP MLD.

For a given link, a non-AP station establishes membership in broadcast TWT schedules of the AP, while the AP delivers broadcast TWT parameter sets to the non-AP stations. The non-AP station is said to be the TWT scheduled station, while the AP is said to be the TWT scheduling station.

Negotiations to become a member of or terminate membership in an rTWT schedule (more generally a broadcast TWT) are performed with an exchange of frames that carry TWT elements as shown below, having the Negotiation Type subfield set to 3 (Broadcast TWT). In particular, a non-AP STA MLD may request to become a member of a TWT schedule by transmitting a TWT Request frame to its associated AP MLD that contains a TWT element for a given rTWT schedule.

The AP then advertises the scheduled broadcast TWT (or rTWT) using broadcast TWT elements in its management frames, typically in the beacon frames, FILS Discovery frames and broadcast Probe Response frames.

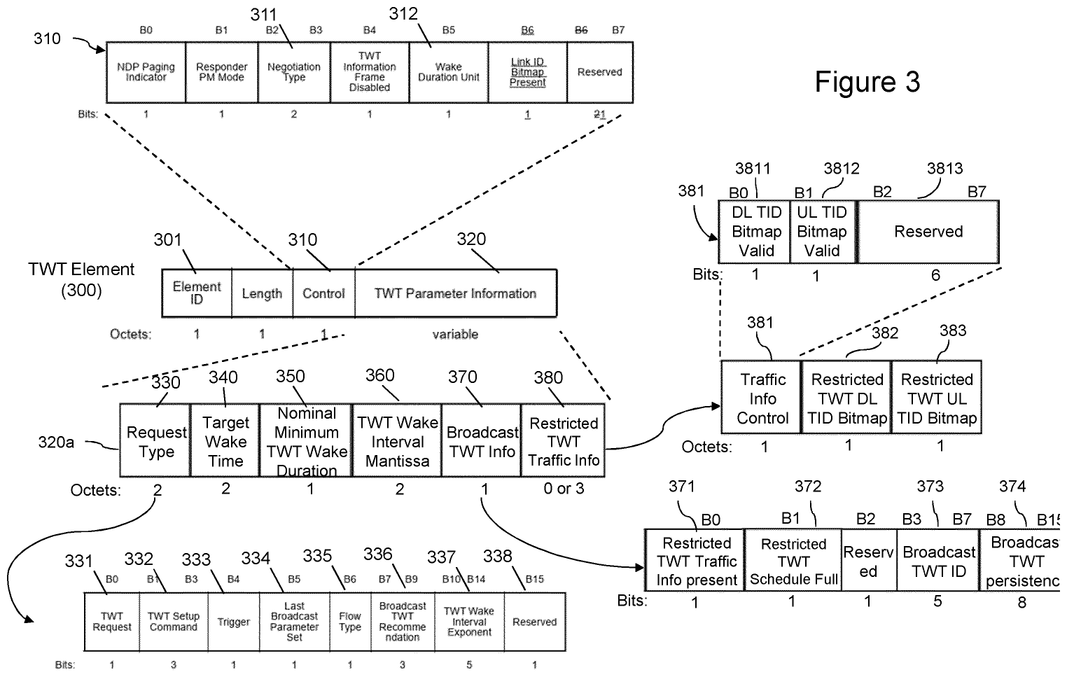

FIG. 3 illustrates a format of a TWT element 300 adapted to be used for r-TWT according to the D2.0 standard.

TWT element 300 is identified by an Element ID 301 and comprises “Control” field 310 and field 320 for transporting TWT parameter information.

“Control” field 310 allows informing through a “Negotiation Type” field 311 whether the TWT is a broadcast TWT or an individual TWT agreement. The MSB of the Negotiation Type subfield 311 is the Broadcast field, therefore the TWT element 300 is referred to as Broadcast TWT element when MSB of subfield 311 is 1. Other fields are of less importance for present description.

“TWT Parameter Information” field 320 contains a single ‘Individual TWT Parameter Set’ field if individual TWT (not shown), and one or more ‘Broadcast TWT Parameter Set’ fields having format 320a shown in the Figure if Broadcast TWT (when Broadcast field of the “Negotiation Type” subfield is 1).

First field in “Broadcast TWT Parameter Set” field 320a is Request Type field 330 comprising:
TWT Request subfield 331 set to 1 when issued by the TWT scheduled STA. Otherwise, set to 0 by the TWT scheduling STA (AP);
TWT Setup Command subfield 332 to indicate the type of TWT command: Request, Suggest, Demand, Reject when issued by a non-AP STA; or Accept, Alternate, Dictate, Reject when issued by a TWT scheduling AP;
Trigger field 333 to indicate whether or not the TWT SP indicated by the TWT element 300 includes triggering frames (the Trigger subfield equals to 1 for r-TWT, for trigger-enabled). Such a TWT SP is named triggered-enabled TWT SP, and a non-AP station cannot start transmitting data within it without previous triggering by the AP;
Broadcast TWT Recommendation field 336 set to 4 to indicate the TWT described in Broadcast TWT element 300 is a restricted TWT (r-TWT). In that case, Broadcast TWT element 300 is also referred to as a restricted TWT element (r-TWT IE), while Broadcast TWT Parameter Set 320a is referred to as Restricted TWT Parameter Set.
Other subfields are of less importance:
   Last Broadcast Parameter Set subfield 334 is set to 0 to indicate that another Broadcast TWT Parameter set follows this set. The Last Broadcast Parameter Set subfield is set to 1 to indicate that this is the last broadcast TWT Parameter set in the broadcast TWT element.
   Flow Type subfield 335 indicates whether the TWT is announced (the TWT scheduling AP will wait to receive a frame from TWT scheduled STA to signal its awake state) or not (Flow Type subfield equals to 0 for r-TWT, for “announced” mode, because r-TWT is a trigger-enabled TWT).

Other fields in Restricted TWT Parameter Set field 320a are used to define time Parameters for the rTWT schedule, as follows:
Target Wake Time (TWT) field 340 indicates the next time (in microseconds) at which the station participating in the rTWT schedule should wake up for the next rTWT SP;
Nominal Minimum TWT Wake Duration field 350 indicates the minimum amount of time that the TWT scheduled STA is expected to be awake since the starting time of the TWT SP in order to complete the frame exchanges for the period of TWT Wake Interval. The TWT Wake Interval of the rTWT SP is the value calculated from the TWT Wake Interval Mantissa 360 and TWT Wake Interval Exponent 337. It is expressed in number of units as defined in Wake Duration Unit subfield 312 of Control field 310, e.g. typically 256 μs.

Other fields in Restricted TWT Parameter Set field 320a are used to define parameters specific to the Broadcast and Restricted nature of the rTWT SP:
Broadcast TWT Info field 370.
   It conveys the identifier of the rTWT schedule, namely the Broadcast TWT ID 373 (bTWT ID), that is used to identify the rTWT SPs belonging to the same rTWT schedule. This identifier, which is not 0, hence allows an AP to schedule multiple sets of Broadcast TWT SPs with different sets of TWT parameters;
   It specifies, through Broadcast TWT Persistence subfield 374, the number of Target Beacon Transmission Times (TBTT) during which the Broadcast TWT SPs corresponding to this Restricted (more generally Broadcast) TWT Parameter set are present;
   It also signals, through Restricted TWT Schedule Full subfield 372, when set to 1, that the r-TWT scheduling AP is unlikely to accept a request from a STA in the BSS to establish a new membership in the corresponding schedule (identified by bTWT ID 373);
   Finally, it also signals, through Restricted TWT Traffic Info Present field 371, whether Restricted TWT Traffic Info field 380 is present (field 371 to 1) or not.
Restricted TWT Traffic Info field 380 specific to the restriction of the Broadcast TWT to specific traffics. This field is mandatory (hence field 371 is mandatorily set to 1) when the broadcast TWT is related to an SCS LL stream (otherwise, the Traffic Info is related to TIDs).
   It comprises Traffic Info Control field 381 that indicates whether the following fields 382 and 383 are provided (i.e. “valid”). DL TID Bitmap Valid subfield 3811 (respectively UL TID Bitmap Valid subfield 3812) indicates whether the Restricted TWT DL TID Bitmap field 382 (respectively Restricted TWT UL TID Bitmap field 383) has valid information.
   Restricted TWT DL TID Bitmap field 382 (respectively Restricted TWT UL TID Bitmap field 383) identifies TIDs as latency sensitive traffic for DL (respectively UL) directions, i.e. TIDs that are allowed in the rTWT defined by Restricted TWT element 300. The TIDs may be those defining SCS streams. A value of 1 at bit position k in the bitmap indicates that TID k is classified as latency sensitive traffic stream for the concerned transmission direction.

The TWT SP of an rTWT schedule is uniquely identified by the <bTWT ID, MAC address of TWT scheduling AP> tuple, where the TWT scheduling AP is the affiliated AP of concerned link of AP MLD.

Thanks to this element included into a TWT Request frame, an initiator STA can request its AP to become an r-TWT scheduled STA, by negotiating r-TWT SPs for its low latency traffics. For example, initiator STA (affiliated of a non-AP MLD) may negotiate the wake TWT, wake interval and the SCS streams to be allowed in the rTWT. The AP (affiliated AP of the AP MLD on that link) provides a TWT Response frame accepting or refusing the request. In other words, the STA requests membership in an rTWT schedule.

A TWT Request frame carries TWT elements with the Negotiation Type subfield 311 set to 3 and the TWT Setup Command field 332 set to Request TWT, Suggest TWT, or Demand TWT. The Restricted TWT Parameter set 320a indicates the Broadcast TWT ID 373 of the rTWT schedule that the STA is requesting to join. The AP has possibility to answer (TWT Response frame) with no new rTWT schedule for the bTWT ID (keep existing one), or offering an alternative set of parameters to those indicated in TWT Request frame, or creating a new rTWT schedule with a new bTWT ID.

Once the negotiation and membership completed, a conventional TWT/rTWT scheduled STA that is in awake state may enter, thanks to the advertising of the rTWT SPs (e.g. through beacon frames), the doze state after receiving a Beacon frame with a Restricted TWT element indicating the existence of an rTWT schedule and switch back to the awake state at the rTWT start times. The Beacon frame indicates an rTWT SP during which the TWT scheduling AP intends to send Trigger frames on that link, or DL BUs to the TWT scheduled STAs.

At the beginning of each TWT/rTWT service period, and expecting the TWT scheduled stations are in the awake state, TWT scheduling AP usually uses OFDMA Multi-User techniques (e.g. MU UL trigger-based transmission, MU DL transmission) to manage the rTWT SP and possibly offer resource units to all or part of the TWT scheduled stations in the awake state.

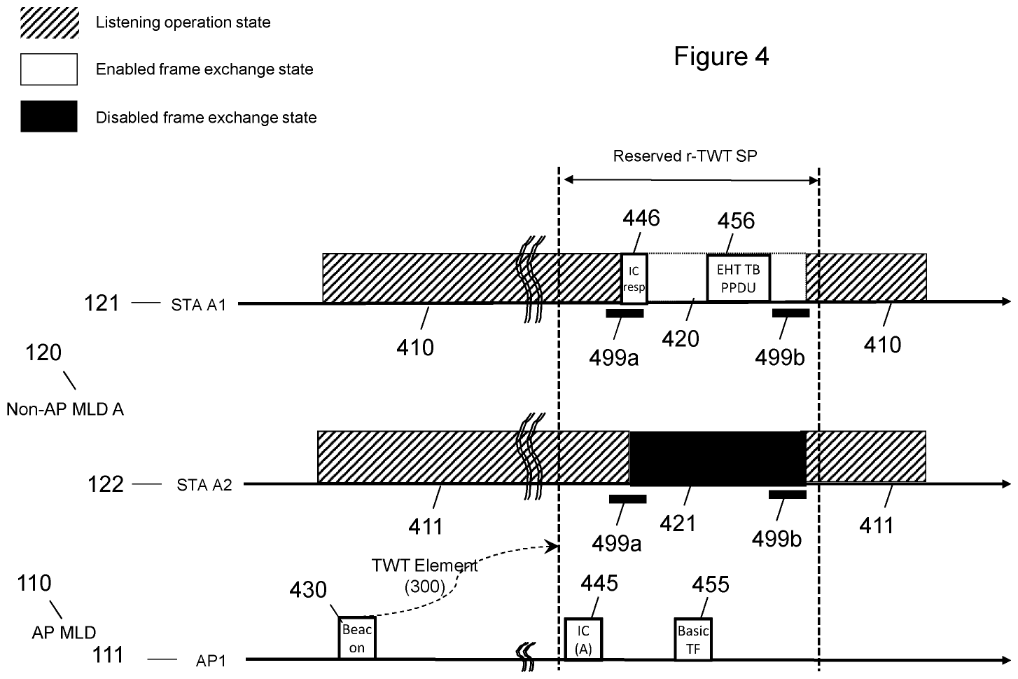

FIG. 4 illustrates, using a frames sequence, a particular embodiment of the EMLSR Operating Mode in non-AP MLD 120 that has negotiated an rTWT service on one of its EMLSR links (e.g. Link 151) with its AP MLD 110. Of course, although the EMLSR mode is emphasized here by way of example, similar considerations can be made with respect to the EMLMR mode.

At the beginning of the sequence, the non-AP MLD enters the EMLSR listening operation mode, meaning its EMLSR co-affiliated STAs are set in the listening operation state, hence they are simultaneously listening to their respective EMLSR links. The non-AP MLD may enter the EMLSR listening operation mode as a response to receiving an EML OM Notification frame with its EMLSR Mode subfield (in the EML Control field) set to 1. In a variant, the non-AP MLD may enter the EMLSR listening operation mode by switching back from the EMLSR frame exchange mode.

As shown with EMLSR-active non-AP MLD 120 in the EMLSR listening operation mode in FIG. 4, both EMLSR co-affiliated STAs A1 121 and A2 122 are both in the listening operation state 410 and 411.

In the example of FIG. 4, EMLSR co-affiliated STA A1 is selected as the station having negotiated an rTWT schedule on Link 151. It may indifferently be the station having the full radio or having the light (reduced function) radio.

Non-AP MLD 120 is able to listen simultaneously on its EMLSR links, by having its EMLSR co-affiliated STA(s) corresponding to those links in “awake” or “listening operation” state. For example, affiliated STAs A1, A2 are in the listening operation state (referenced 410 and 411). The listening operation includes CCA (Clear Channel Assessment) and receiving an initial Control frame of frame exchanges that is initiated by the AP MLD. In non-AP MLD 120, the two EMLSR co-affiliated STAs therefore simultaneously listen for receiving the initial Control frame from the AP MLD, but also beacon frames (this is because such beacon frames are also emitted with low MCS and non-HT format).

By receiving beacon frame 430, the affiliated STA A1 can therefore be able to determine the dedicated transmission windows (rTWT) to be reserved for it on Link 151.

Then, at starting of this reserved rTWT service Period, the AP MLD 110 intends to initiate frame exchanges with one or more non-AP MLDs on one of the EMLSR links, it begins the frame exchanges by transmitting the initial Control frame 445 which explicitly triggers the non-AP MLD.

The EMLSR co-affiliated STA of the non-AP MLD explicitly triggered by the initial Control frame 445 that receives the frame, e.g. affiliated STA A1 in the example, initiates a state change of the EMLSR co-affiliated STA of the non-AP MLD considered, e.g. a change of the states of affiliated STAs A1 and A2 in the example, and sends an Initial Control frame response (IC resp.) 446 to the AP AP1 affiliated with the AP MLD 110.

In case where response 446 is to be sent, after an EMLSR active switch delay 499a, non-AP MLD 120 switches to EMLSR frame exchange mode where EMLSR co-affiliated STA A1 121 switches from the listening operation state 410 to the enabled frame exchange state 420, while EMLSR co-affiliated STA A2 122 simultaneously switches from the listening operation state 411 to the disabled frame exchange state 421.

Frames 455, 456 are then exchanged during the frame exchange sequence, up to the end of the sequence where the non-AP MLD 120 switches back to the EMLSR listening operation mode.

Typically, affiliated AP1 111 may transmit a basic trigger frame 455 to EMLSR co-affiliated STA A1 121 in order to allocate uplink resources units for non-AP MLD 120. In such a case, non-AP MLD 120 via EMLSR co-affiliated STA A1 121 transmits an EHT TB (Extremely High Throughput Trigger-Based) PPDU 456 in its allocated resource unit.

Once the frame exchange ends over link 151, non-AP MLD 120 invokes again the state switching procedure to switch EMLSR co-affiliated STAs A1 121 and A2 122 back to their listening operation state 410, 411. Non-AP MLD 120 therefore switches back to the EMLSR listening operation mode. The switch back 499b is operative an EMLSR Transition Delay (as specified in the EML Capabilities) after the end of the frame exchange inside the service period.

In case where the AP1 111 affiliated with the AP MLD 110 transmits an initial (Control) frame that initiates frame exchanges with at least one non-AP MLD operating in the EMLSR mode and at least one non-AP MLD operating in the EMLMR mode, the AP ensures that the padding duration of the Padding field of the initial Control frame is greater than or equal to the maximum of the values indicated in the EMLSR Padding Delay subfield and EMLMR Delay subfield of the Basic Multi-Link element received from the non-AP MLDs with which the frame exchanges are initiated. The transition period 499a, in view point of individual STA MLD 120, fits within delay referred generally to “EML active switch delay” from AP's viewpoint, consisting of the maximum of “EMLSR active switch” delays and “EMLMR active switch” delays of triggered stations.

In other words, the AP1 111 affiliated with the AP MLD 110 transmits an initial frame that triggers a frame exchange with at least one non-AP MLD operating in the EML Single-Radio, EMLSR, mode and at least one non-AP MLD operating in the EML Multi-Radio, EMLMR, mode. The AP MLD ensures that a padding duration of a Padding field of the initial frame is greater than or equal to the maximum of the values indicated in an EMLSR Padding Delay subfield received from the at least one non-AP MLD operating in the EMLSR mode and an EMLMR Delay subfield received from the at least one non-AP MLD operating in the EMLMR mode.

The exemplary scenario of FIG. 4 shows that the EML operation modes and TWT (e.g. rTWT) mechanism can theoretically work in combination. They would advantageously allow EML stations to transport their latency sensitive streams in dedicated transmission windows (rTWT) reserved for them. However, the resulting overall mechanism is still deficient:
The initial Control frame 445 which explicitly triggers the non-AP MLD, and the corresponding response 446, provide important overhead inside the critical resource dedicated to latency sensitive streams.
In order to take profit of the scheduled rTWT SP, an EML STA shall know when SP will occur: Therefore, this mandates that EML STA needs also taking care of beacon reception, which is not yet envisaged by 802.11be standard.

In general, mechanisms or procedures operating per link procedure, such as the exemplary Target Wake Time (TWT) or its recent adaptation known as Restricted Target Wake Time (rTWT), may not fully be adapted to the EML modes where the EMLSR or EMLMR links are not entirely independent one of the other.

It has been sought to efficiently manage EML modes for an EML non-AP MLD, once a first affiliated STA of the EML non-AP MLD has negotiated a medium access service or mechanism on a first link of its EML links. When such a mechanism (link-specific procedure) is determined based on the reception of a beacon frame on the first link by the first affiliated STA, the latter should not be in blind mode during the reception of the beacon frame, and thus a second affiliated STA of the same EML non-AP MLD should not be in communication over a second other link of the EML links during that period.

Typically, for a TWT schedule in which the initiator non-AP station (e.g. STA A1) has established membership with the AP of the BSS (AP 111), the affiliated STA (A1) has to be awake for the reception of beacon frames indicative of the TWT service period (on Link 151), hence to be available at the early beginning of service periods to come in this rTWT schedule.

While further embodiments will be described with regards to TWT (rTWT), the invention can be broadened to other link-specific procedures and should not be limited to TWT mechanism. As example, Quiet element corresponding to quiet intervals scheduled to protect r-TWT SPs is also a mechanism specialized per link (i.e. a link-specific procedure).

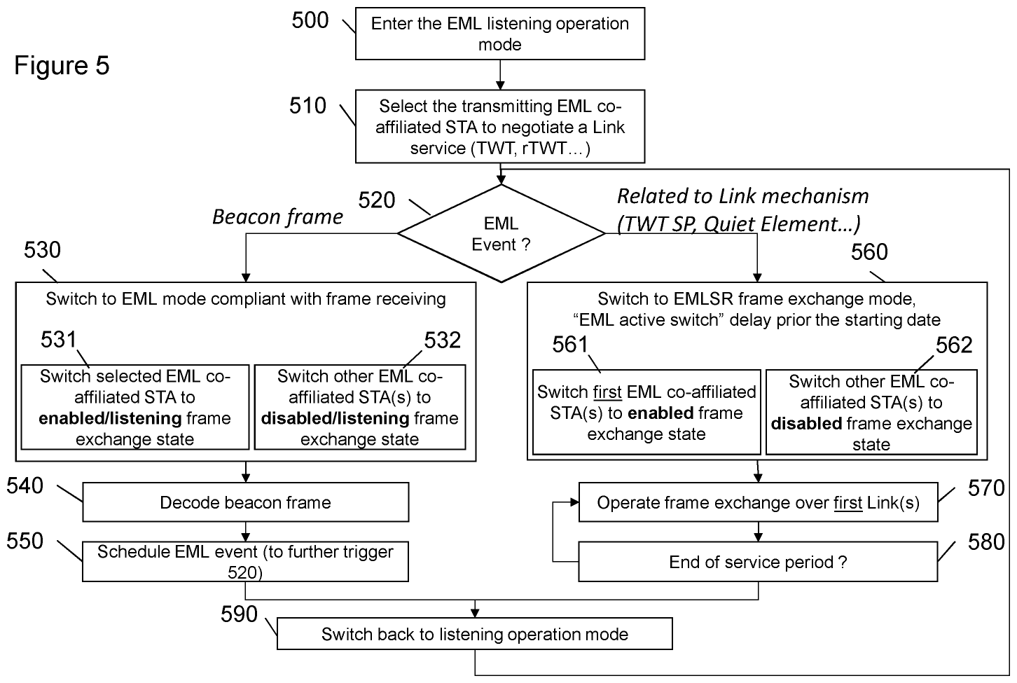

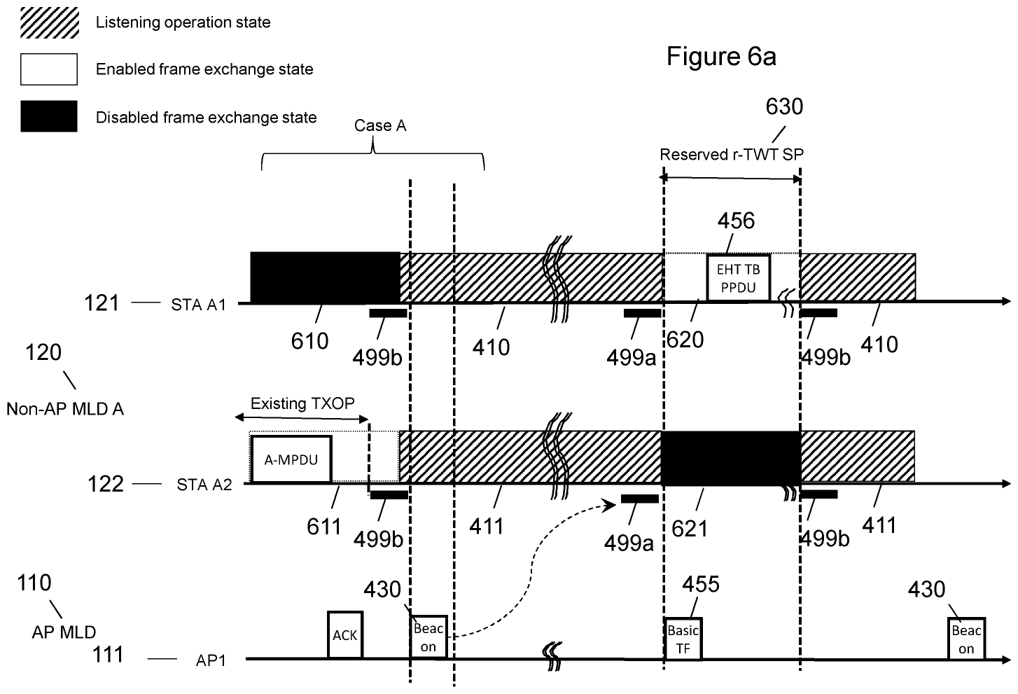

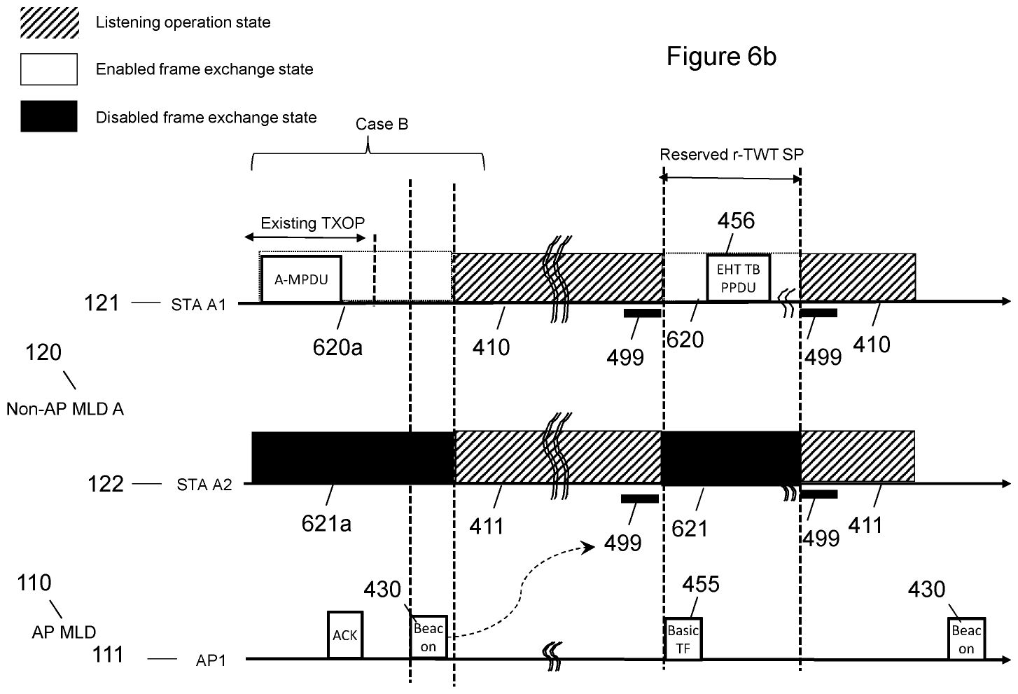

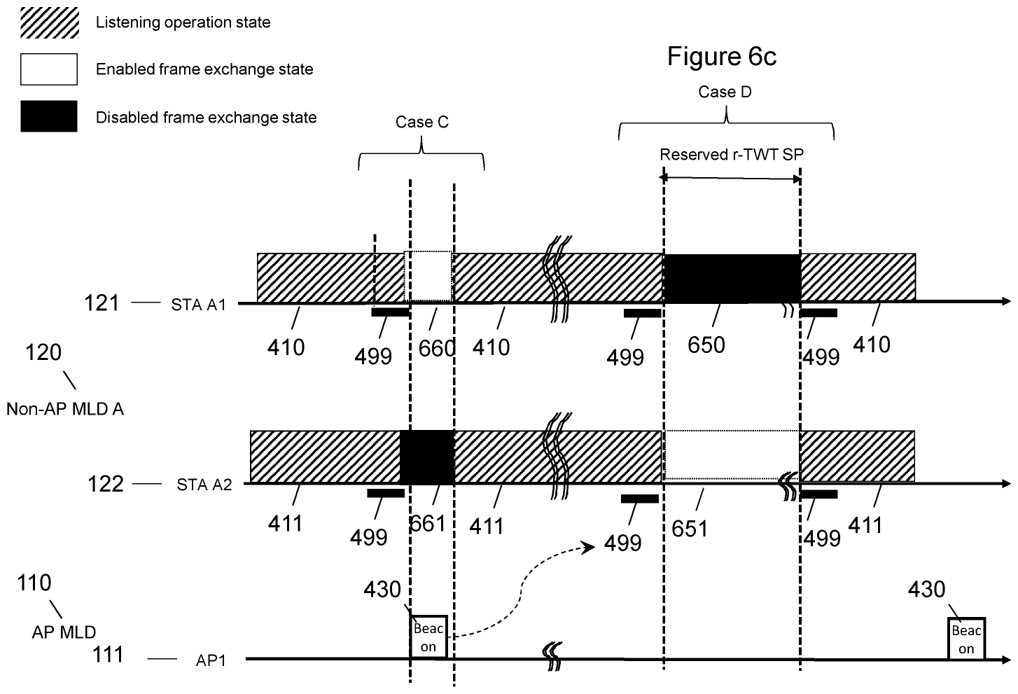

Exemplary embodiments of the invention are illustrated by FIGS. 5, 6a, 6b and 6c.

FIG. 5 illustrates, using a flowchart, steps performed by an EMLSR-active non-AP MLD to operate TWT service (service period schedule obtaining and channel access procedure), according to embodiments of the invention. FIGS. 6a and 6b schematically illustrate exemplary timelines of the TWT operation as described in FIG. 5.

For ease of explanation, it is mainly made reference to the EMLSR mode only, whereas the same applies to the EMLMR mode.

The process starts at step 500 where the non-AP MLD enters the (EMLSR or EMLMR) listening operation mode, meaning its co-affiliated STAs are set in the listening operation state, hence they are simultaneously listening to their respective (EMLSR or EMLMR) links. The non-AP MLD may enter the listening operation mode as a response to receiving an EML OM Notification frame with its corresponding Mode subfield (EMLSR or EMLMR Mode subfield in the EML Control field) set to 1. In a variant, the non-AP MLD may enter the listening operation mode by switching back from the frame exchange mode.

At step 510, the non-AP MLD waits until it has buffered latency sensitive data to be transmitted to AP MLD 110 (uplink). One may also consider latency sensitive data to be transmitted to other non-AP MLD through a direct link under the control of AP MLD 110 (triggered direct-link data). As mentioned above, such data may be provided by upper layers and stored in the buffers 210 of the non-AP MLD. The non-AP MLD determines the TWT negotiation to be activated on one of the EMLSR or EMLMR links (Link 151 is that one selected Link in the FIGS. 6a and 6b).

In some embodiments, where a TID-To-Link mapping is negotiated between the AP MLD and the non-AP MLD to map some TIDs to a set of links and some other TIDs to another set of links, buffered latency sensitive data corresponds to TID(s) allowed to be transported on the selected link and are indicated in bitmaps 3811 and/or 3912 of TWT element 320a of rTWT format.

Responsive to successful establishment of TWT mechanism over the first link, a schedule operation (identical as step 550 further described) could be performed concerning the reception date of next beacon frame (that is to say for next TBTT occurrence).

Next, in test step 520, various events allow the non-AP MLD to perform an EML configuration by its own according to embodiments. This could be the detection of a beacon frame on the link of interest (selected link, e.g. 151), or a scheduled EML event according to the invention (e.g. an EML event scheduled prior to TWT service period starting).

EML events related to the reception of a Beacon frame (the real receiving and/or a scheduled event prior to a TBTT for the link) are processed through steps 530 to 550.

Indeed, in that case, the non-AP MLD shall not be engaged in a frame exchange over any of its EMLSR or EMLMR link.

Various configurations are possible for step 530:
If no activity on any link, a state switching procedure is invoked by the non-AP MLD to continue its mode on the listening operation mode, where the co-affiliated STAs are mandated to maintain this listening mode until the end of beacon frame reception (steps 531 and 532). In addition, those EML co-affiliated STAs shall ignore any initial Control frame addressed to it that overlaps in time the beacon frame transmitted on the selected link (TBTT on the intended link).
As alternate embodiment, the selected co-affiliated STA (corresponding to the selected link where beacon frame is intended to be transmitted, e.g. Link 1 151) is switched (step 531) from the listening operation state to the enabled frame exchange state to be able to perform a frame exchange (even if just willing to receive a beacon frame), while in parallel (synchronously or simultaneously), the other co-affiliated STA (e.g. one of Link 2) of the EMLSR or EMLMR links set is switched (step 532) from the listening operation state to the disabled frame exchange state. This would easily avoid reception of any IC frame on other link(s). This case is illustrated by FIG. 6c, with sub-sequence “Case C”.
If there are frame exchanges on the other EML link(s), the co-affiliated STA of the other link is requested to end its participation to the TXOP (Transmit Opportunity), and be in an EML mode compliant with the reception of beacon frame. This case is illustrated by FIG. 6a, with sub-sequence “Case A”.
A state switching procedure is invoked by the non-AP MLD for each of the EMLSR or EMLMR co-affiliated STAs, so that they switch back to the EML listening operation state. This would allow co-affiliated STA1 121 to successfully be in capacity to receive the beacon frame 430.
If there are frame exchanges on the selected EML link, the transmitting EMLSR co-affiliated STA (selected link) remains in the enabled frame exchange state and waits for the medium being back to the idle state (it may end its existing TXOP, as legacy stations do when the TBTT time issuance is close). The other EMLSR co-affiliated STAs also keep their current states (disabled, step 532). This will last the beacon frame reception. This case is illustrated by FIG. 6b, with sub-sequence “Case B”.

In other words, in step 530, the configuration of the selected co-affiliated STA or first affiliated station (corresponding to the selected link or first link where beacon frame is intended to be transmitted, e.g. Link 1 151) by the non-AP MLD 120 includes:
Case A: ending an on-going frame exchange over the second link of the EML links and switching the first affiliated station into an operation state compliant with receiving the second beacon frame (e.g., in a first variant, by switching the first affiliated station into a listening operation state, and in this case a second affiliated station shall ignore any initial frame that triggers a frame exchange sequence over the second link and that overlaps in time the first beacon frame on the first link; and, in a second variant, by switching the first affiliated station into an enabled frame exchange state); or
Case B: ending an on-going frame exchange over the first link and maintaining the first affiliated station in an enabled frame exchange state (e.g. maintaining if a time distance to the TBTT is smaller than a predefined threshold, this predefined threshold being in a particular embodiment at least the sum of a (first) transition period needed by the non-AP MLD to switch the state of its affiliated stations from the listening operation state to the enabled or disabled frame exchange states and a (second) transition period needed by the non-AP MLD to switch the state of its affiliated stations from the enabled or disabled frame exchange state to the listening operation state); or
Case C: switching the first affiliated station from a listening operation state into an enabled frame exchange state.

As a result, in step 540, the selected EMLSR co-affiliated STA can receive the Beacon frame, and analyse its contents.

As example of contents of interest for present embodiments, TWT Information Element 300 can be analyzed in order to confirm the scheduling of TWT service periods (e.g. the wake TWT and wake interval via fields 340, 360, 337).

In order to quieting STAs during r-TWT service periods, an r-TWT scheduling AP may schedule a quiet interval that overlaps with a r-TWT SP for a given link. Overlapping quiet intervals may be scheduled by including one or more Quiet elements in the Beacon frames. Therefore, Quiet Element is another example of contents of interest for present embodiments: that is to say, a non-AP MLD shall not be engaged in transmission during any quiet interval. Even more, non-AP MLD thus determines one of its co-affiliated STA shall be quiet during a Quiet interval that corresponds to an r-TWT service periods it is not a member of.

Next (step 550), the non-AP MLD can schedule EML event(s) responsive to the mechanisms determined through beacon frame.

First, the non-AP MLD schedules itself to be awake for next TBTT on the selected link.

In other words, on the next TBTT occurrence (considering the present TBTT occurrence relates to a first beacon frame), test step 520 will be carried out again and will indicate detection of an EML event relating to a next (second) beacon frame, thus steps 530 to 550 will be carried out again. Therefore, the non-AP MLD carries out a communication method comprising:
receiving, by a first affiliated station (e.g. STA A1), a first beacon frame over a first link (e.g. 151) of the EML links, the first beacon frame including a Target Beacon Transmission Time, TBTT, related to a second beacon frame; and
configuring the first affiliated station (e.g. STA A1) to be in a receiving state at the TBTT to receive the second beacon frame.

As option, after association with the AP MLD, one may consider the non-AP MLD schedules its event for TBTT timing on all the EML links: this is to be able to determine Link-specific procedures for all of its EML links (e.g. Quiet Element for TWT that it is not member of). When a Link-specific procedure has been negotiated in step 510, the non-AP MLD can schedule itself for beacon frames on the selected link, for initial discovery of TWT/rTWT element indicative of a service period for the TWT service it has negotiated.

Concerning further beacon TBTT scheduling, related to TWT operation, the non-AP MLD may relax the constraint of each TBTT for the selected Link: the indications of Broadcast TWT Persistence subfield 374 may allow to determine the number of Target Beacon Transmission Times (TBTT) during which the Broadcast TWT SPs corresponding to this Restricted (more generally Broadcast) TWT Parameter set are present, therefore the intermediate TBTT could be ignored (only beacon frame of last TBTT of persistence information may contain new information).

In other words, in the above-mentioned context where the non-AP MLD configures the first affiliated station (e.g. STA A1) to be in a receiving state at the TBTT to receive the second beacon frame, the second beacon frame includes another TBTT related to a third beacon frame that schedules a TWT service period on the first link, and in case the scheduled TWT service period is signaled with a TWT persistence, a frame exchange performed by a second affiliated station continues over a second link of the EML links without configuring the first affiliated station to be in a receiving state at the other TBTT to receive the third beacon frame over the first link.

As will become apparent on FIGS. 6a to 6c, the scheduled event is preferably prior to the issuance date (of beacon frames or TWT periods), such as an “EML active switch delay” 499/499a is unforced.

This is because the simultaneous switches last at most the EMLSR or EMLMR active switch delay as specified earlier and shown by reference 499/499a in the Figures. In the example, EMLSR co-affiliated STA A1 is selected. It may indifferently be the station having the full radio or having the light (reduced function) radio. In practice, the switch for the EMLSR co-affiliated STA having the full radio (only antenna connection is required) is shorter than the switch for the other EMLSR co-affiliated STA having the light radio (due to the required physical and reconfiguration of the full radio chain), therefore the non-AP MLD is able to adapt it scheduling in order to consider the appropriate timing 499/499a with regards to its hardware configuration (e.g. reduce the scheduling margin for Link configured with full radio).

As addition, the non-AP MLD is also able to adapt it scheduling in order to consider current activity prior to the event of interest: a timing margin can be envisaged to stop any existing TXOP (FIGS. 6a and 6b), prior the switch delay 499/499a.

In practice, the scheduling operation is performed by non-AP MLD at its upper-MAC 230. This is because this entity collects management frame information from all links, and may configure accordingly the lower MACs entities 220-x/220-y/220-z. As Upper-MAC is able in charge of frame decoding, it could obtain TBTT of all links, therefore it seems preferable that U-MAC 230 controls the activity of L-MACs (e.g. de-activates temporarily activity on medium, or forces “listening” mode).

One may also consider informing first a LL-MAC on stopping its TXOP activity, then informing of the EML configuration switching as described per FIG. 5.

Once the beacon frame reception ends over Link 1, the non-AP MLD invokes again the state switching procedure to switch its co-affiliated STAs back to their listening operation states (step 590). The non-AP MLD therefore switches back to the listening operation mode. The switch back is operative an EMLSR Transition Delay (as specified in the EML Capabilities) or an EMLMR transition Delay (as specified above, according to implementations of the invention) after the end of the frame exchange.

Back to test 520, an EML event scheduled by step 550 concerning a link-specific mechanism is processed through steps 560 to 580.

Purpose of step 560 is to configure the non-AP MLD to be in appropriate state on the link of interest. A state switching procedure is therefore invoked for each of the EML co-affiliated STAs, accordingly:
When the scheduled EML event regards with an (r-)TWT service period, the non-AP MLD aims to be in active state for the link where and when the (r-)TWT period will start. The “first” link of step 561 is thus the one corresponding to the selected co-affiliated STA.
The STA affiliated with the non-AP MLD on the corresponding link, i.e. the receiving EMLSR co-affiliated STA A1 in the example of FIGS. 6a and 6b, is configured to be able to transmit or receive frames on the enabled link during the TWT service period (step 561). As become apparent further, EMLSR co-affiliated STA A1 does not need to receive an initial Control frame for frame exchanges, therefore saving resources in the TWT SP.
Simultaneously, the other EMLSR co-affiliated STAs of the same non-AP MLD, i.e. STA A2 in the example of FIGS. 6a and 6b) are configured not to transmit or receive on the other EMLSR link(s) until the end of the TWT period. To do so, a state switching procedure is also invoked for the other EMLSR co-affiliated STAs which in turn are switched from the listening operation (step 562) to a “blindness frame” or “disabled frame exchange” state.
When the scheduled EML event regards with a Quiet Element for (r-)TWT service period, the non-AP MLD aims to be in disabled state for that link where and when the quiet period will start.
To do so, the selected EMLSR co-affiliated STA of the same non-AP MLD, i.e. STA A1 in the example that belongs to the link where the beacon frame was issued, is configured not to transmit or receive until the end of the frame exchanges (step 562). The other EMLSR co-affiliated STAs of the same non-AP MLD may be switched to the listening operation state (if even possible by hardware, in complement of the one link been disabled), or alternatively better, at most one among other EMLSR co-affiliated STAs of the same non-AP MLD (i.e. STA A2 in the example) switches from the listening operation state to an “active frame exchange” or “enabled frame exchange” state (step 561).
In other words, in the above-mentioned context where the non-AP MLD configures the first affiliated station (e.g. STA A1) to be in a receiving state at the TBTT to receive the second beacon frame, the second beacon frame schedules a quiet period on the first link, and at a time of the quiet period, switching the first affiliated station to a disabled frame exchange state until an end of the quiet period. Moreover, at the time of the quiet period, the non-AP MLD switches a second affiliated station to an enabled frame exchange state over a second link of the EML links until an end of the quiet period.

As already discussed, an “EML active switch delay” has been preferably considered for the effectiveness of configuration at the appropriate date.

The state switches of all the EMLSR co-affiliated STAs within the same non-AP MLD are inseparable, hence simultaneous, because it is a question of allocating a full radio resource chain (see FIG. 9a below) to one of the STAs while the others are deprived of such chain. With respect to the EMLMR mode, the physical resources (e.g. antennas) of one radio resource chain are allocated (and aggregated) to the other radio resource chain, the former being therefore deprived of transmission/reception capabilities (see FIG. 9b below).

The above shows that when a non-AP MLD operates in the EMLSR mode (and more generally in any of the EMLSR and EMLMR mode), it is either in a listening operation mode (its co-affiliated STAs are in the listening operation state) or in a frame exchange mode (one of its co-affiliated STAs is in the enabled frame exchange state while the other co-affiliated STAs are in the disabled frame exchange state).

After the configuration of step 560, a step 570 (in which the receiving EMLSR co-affiliated STA A1 in the example of FIGS. 6a and 6b operates frame exchange on the enabled link (first link) during the TWT service period) lasts until step 580 (end of service period). The duration is obtained from TWT IE or Quiet Element.

For TWT, Nominal Minimum TWT Wake Duration field 350 indicates the minimum amount of time that the TWT scheduled STA is expected to be awake since the starting time of the TWT SP in order to complete the frame exchanges for the period of TWT Wake Interval. Therefore, the switch back is operative an EMLSR Transition Delay (as specified in the EML Capabilities) after the end of the service period, and not the end of frame exchange inside. This provides also more space inside the TWT SP for latency sensitive data transmission.

Exemplary frame exchange sequences are shown in the following Figures.

FIGS. 6a and 6b present enhanced frame exchange sequences with regards to TWT mechanisms support by EMLSR stations according to the invention. For ease of figures description, it is mainly made reference to the EMLSR mode only, whereas the same applies to the EMLMR mode.

In the examples, EMLSR co-affiliated STA1 121 is selected as the station having interest in a per-link procedure. It may indifferently be the station having the full radio or having the light (reduced function) radio.

The simultaneous switches last at most the EMLSR active switch delay as specified earlier and shown by reference 499a/499b in the Figures. In practice, the switch for the EMLSR co-affiliated STA having the full radio (only antenna connection is required) is shorter than the switch for the other EMLSR co-affiliated STA having the light radio (due to the required physical and reconfiguration of the full radio chain). So the values considered for 499a/499b may be corresponding to the radio configuration of STA A1 (or the greatest of each respectively).

As shown with EMLSR-active non-AP MLD 120 in FIG. 6a, both EMLSR co-affiliated STAS A1 121 and A2 122 have switched (in the past, not shown) from the listening operation to a “blindness frame” or “disabled frame exchange” state 610 for STA1 121 and respectively to an “active frame exchange” or “enabled frame exchange” state 611 for STA2 122.

As described earlier with regards to step 530, both the ending of TXOP participation by STA A2 and the switching that last period 499b are taken into account, especially here for terminating phases 610 and 611. Ending of TXOP can be performed by several manners, even by shortening its data communication or not responding to a peer device (AP of the Link 2), even by issuing a CF-End frame if STA A2 is the TXOP holder.

As a result, when a non-AP STA, which is affiliated with a non-AP MLD and is operating on one of a pair of EMLSR or EMLMR links, aims to receive a broadcast management frame (beacon frame 430) on the first link (151); if the second non-AP STA (STA A2) affiliated with the same MLD participates in frame exchange on the second link (152) that overlaps with the TBTT of first link, then the second non-AP STA (STA A2) and its associated AP (referred to as the second AP), should follow the rules below:
The second AP as a TXOP holder on the second link (152) should ensure its TXOP ends no later than T amount of time before the TBTT on the first link,
The second non-AP STA (STA A2) as a TXOP holder on the second link (152) should ensure its TXOP ends no later than T amount of time before the TBTT on the first link.

In embodiments, T equals to one of the following values:
the EMLSR transition delay (499b), indicated in the EMLSR Transition Delay subfield, as specified for the pair of EMLSR links if the two non-AP STAs belong to a pair of EMLSR links,
the EMLMR delay, indicated in the EMLMR Delay subfield as specified for the pair of EMLMR links if the two non-AP STAs belong to a pair of EMLMR links (i.e. the EMLMR deactive switch delay as specified before, according to an implementation).

When several non-AP STAs are operating in the TXOP in the second link (152), then the second AP as a TXOP holder on the second link (152) should ensure that T is greater than or equal to the maximum individual T values (as determined here before) for those non-AP STAs.

In other embodiments, T equals to one of the following values:
the EMLSR transition delay (499b), indicated in the EMLSR Transition Delay subfield, as specified for the pair of EMLSR links if the two non-AP STAs belong to a pair of EMLSR links;
EMLMR delay+aSIFSTime+Transmission time of initial response frame (i.e. the EMLMR deactive switch delay as specified before, according to an implementation) if the two non-AP STAs belong to a pair of EMLMR links.

The duration of initial response frame can be different depending on the initial frame. The non-AP MLD and AP MLD may determine the duration when the shortest initial response frame is used on EMLMR links (e.g., a CTS frame in non-HT PPDU with the highest rate in the BSSBasicRateSet parameters).

When several non-AP STAs are operating in the TXOP in the second link (152), then the second AP as a TXOP holder on the second link (152) should ensure that T is greater than or equal to the maximum individual T values (as determined here before) for those non-AP STAs.

The simultaneous switches (e.g. to make all co-affiliated STAs into a “listening” mode) last at most the EMLSR active switch delay or the EMLMR active switch delay as specified earlier.

In other words, the configuration of the selected co-affiliated STA or first affiliated station (STA A1) (corresponding to the selected link or first link where beacon frame is intended to be transmitted, e.g. Link 1 151), by the non-AP MLD 120, is triggered at least a first determined delay before the TBTT (e.g. EMLSR active switch delay, EMLMR active switch delay or a maximum of the EMLSR and EMLMR active switch delays).

This will make possible the reception of a beacon frame on Link 1 (by STA A1). In addition, other EML co-affiliated STA(s) (here STA A2) shall ignore any initial Control frame addressed to it that overlaps in time the beacon frame of selected link (TBTT on the intended link), if any.

This mode may also be advantageous in order to receive beacon frames over the two EML links (if synchronized in time).

Once the beacon frame has been received, all EML co-affiliated STAs can perform their usual operations.

Next, the reserved period will arrive to date (630).

Compared to FIG. 4, the EML scheduler has envisaged scheduling the switching of “active frame exchange” or “enabled frame exchange” state for STA1 prior to the starting of intended TWT SP 630. Typically, the switch delay 499/499a (belonging to the group comprising: an EMLSR active switch delay, an EMLMR active switch delay and a maximum of the EMLSR and EMLMR active switch delays) occurs before the TWT SP 630.

In the same way as Case A but applied to this TWT SP 630, any medium activity on EML links shall have ceased (not represented in the figure).

As a result, when a non-AP STA, which is affiliated with a non-AP MLD and is operating on one of a pair of EMLSR or EMLMR links, is a member of a R-TWT SP on the first link (151); if the second non-AP STA (STA A2) affiliated with the same MLD is not a member of any other R-TWT SPs on the second link (152) that overlap with the first SP, then the second non-AP STA (STA A2) and its associated AP (referred as the second AP), should follow the rules below:
The second AP as a TXOP holder on the second link (152) should ensure its TXOP ends no later than T amount of time before the start time of the R-TWT SP on the first link;
The second non-AP STA (STA A2) as a TXOP holder on the second link (152) should ensure its TXOP ends no later than T amount of time before the start time of the R-TWT SP (630) on the first link.

In embodiments, T equals to one of the following values:
the EMLSR transition delay (499b), indicated in the EMLSR Transition Delay subfield, as specified for the pair of EMLSR links if the two non-AP STAs belong to a pair of EMLSR links,
the EMLMR delay, indicated in the EMLMR Delay subfield as specified for the pair of EMLMR links if the two non-AP STAs belong to a pair of EMLMR links (i.e. the EMLMR deactive switch delay as specified before, according to an implementation).

When several non-AP STAs are members of a R-TWT SP on the first link (151) and operate in the TXOP in the second link (152), then the second AP as a TXOP holder on the second link (152) should ensure that T is greater than or equal to the maximum individual T values (as determined here before) for those member non-AP STAs.

In other embodiments, T equals to one of the following values:
the EMLSR transition delay (499b), indicated in the EMLSR Transition Delay subfield, as specified for the pair of EMLSR links if the two non-AP STAs belong to a pair of EMLSR links,
EMLMR delay+aSIFSTime+Transmission time of initial response frame (i.e. The EMLMR deactive switch delay as specified before, according to an implementation) if the two non-AP STAs belong to a pair of EMLMR links.

The duration of initial response frame can be different depending on the initial frame. The non-AP MLD and AP MLD may determine the duration when the shortest initial response frame is used on EMLMR links (e.g., a CTS frame in non-HT PPDU with the highest rate in the BSSBasicRateSet parameters).

When several non-AP STAs are members of a R-TWT SP on the first link (151) and operate in the TXOP in the second link (152), then the second AP as a TXOP holder on the second link (152) should ensure that T is greater than or equal to the maximum individual T values (as determined here before) for those member non-AP STAs.

As an initial (Control) frame 445 used to explicitly trigger the non-AP MLD and the corresponding response 446 provide important overhead inside the critical TWT SP resource dedicated to latency sensitive streams, and as the TWT SP is already determined, the non-AP MLD may configure its affiliated EML STAs to be ready to operate during the TWT SP 630.

When non-AP MLD 120 desires to initiate a frame exchange sequence with AP MLD 110 during the TWT SP 630 (EMLSR co-affiliated STA A1 121 selected as transmitting EMLSR co-affiliated STA in the negotiated TWT), it switches the EMLSR co-affiliated STA A1 121 from the listening operation state 410 to the enabled frame exchange state 620, while in parallel (synchronously or simultaneously), it switches EMLSR co-affiliated STA A2 122 from the listening operation state 411 to the disabled frame exchange state 621.

The listening operation state is restored and operative after the end of the TWT SP 630, corresponding to the switch back (period 499b defined by the EMLSR Transition Delay set in the EML Capabilities).

In other words, in the above-mentioned context where the non-AP MLD configures the first affiliated station (e.g. STA A1) to be in a receiving state at the TBTT to receive the second beacon frame, the second beacon frame schedules a service period on the first link, and upon ending a frame exchange within the service period, the non-AP MLD maintains the first affiliated station in an enabled frame exchange state until an end of the service period. In a particular embodiment, the non-AP MLD switches the first affiliated station in an enabled frame exchange before the start of the service period and maintains it in the enabled frame exchange state until the end of the service period. Moreover, at the end of the service period, the non-AP MLD switches the first affiliated station from the enabled frame exchange state to the listening operation state.

The EMLSR co-affiliated STAs switch back to the listening operation mode, regardless of the duration field in the frame that triggers it (Basic Trigger 455) (or more generally after the end of the frame exchange with its AP), but with regards of the overall service period 630. This would support several frame exchanges with the AP (if any) during the service period 630, with no need of overhead due to further initial (Control) frame/response EML enabling sequence.

FIG. 6b presents a variant of frame exchange sequences compared to FIG. 6a, wherein the EMLSR co-affiliated STAs A1 121 and A2 122 start respectively in an “active frame exchange” or “enabled frame exchange” state 611 for STA1 121, and in a “blindness frame” or “disabled frame exchange” state 610 for STA2 122.

Only the sequence underline by “Case B” is different.

The STA1 121 is already operating on the EMLSR link 151 for frame exchanges with the AP MLD.

Usually, according to 802.11be D0.5, when a STA of the non-AP MLD initiates a TXOP, the non-AP MLD shall switch back to the listening operation on the EMLSR links after the time duration indicated in the EMLSR Transition Delay subfield (499b) after the end of the TXOP.

This rule is adapted to current situation, where a TBTT is next to the TXOP. As already discussed, the TXOP on Link 151 can be shortened to respect the TBTT time on that link.

Embodiments provide the non-AP MLD keep the current EML configuration until the reception of beacon frame: the co-affiliated STAA1 remains on the enabled frame exchange state 620a in order to be able to receive the beacon frame, and co-affiliated STA A2 remains to the disabled frame exchange state 621a (this would avoid any changing EML mode due to reception of an Initiating Frame during that period).

With different behavior, the non-AP MLD first determines the duration remaining time upon TBTT, and decides based on the time whether to switch back to the listening operation mode or to remain in the current EMLSR frame exchange mode. For example, if the time is long, i.e. its value is higher than a threshold, the EMLSR co-affiliated STAs are switched back to the listening operation mode (therefore conducting to the situation of Case C illustrated in FIG. 6c herebelow). And if the duration is short, i.e. its values is lower than the threshold, the EMLSR co-affiliated STAs remain in their current states.

FIG. 6c first presents enhanced frame exchange sequences (“Case C”) with regards to support of beacon frame by EML stations according to embodiments.

Embodiments provide the non-AP MLD to switch only one EMLSR co-affiliated STA to an active state (i.e. to the enabled frame exchange state for the selected EMLSR co-affiliated STA, and to the disabled transmitting EMLSR co-affiliated STA for the other EMLSR co-affiliated STA).

In the figure, the co-affiliated STA (corresponding to selected link where beacon frame is intended, e.g. Link 1 151) is switched from the listening operation state to the enabled frame exchange state 660 to be able to perform a frame exchange (even if just willing to receive a beacon frame), while in parallel (synchronously or simultaneously), the other co-affiliated STA (e.g. one of Link 2) of the EMLSR or EMLMR links set is switched from the listening operation state 411 to the disabled frame exchange state 661.

FIG. 6c also presents enhanced frame exchange sequences (“Case D”) with regards to support of Quiet Period for rTWT mechanism by EML stations according to the invention.

This corresponds to application of step 561 for a scheduled Quiet Period event. In embodiments, this may correspond to a Quiet period encompassing an (r-)TWT service period for which the EML station is not member of.

In that context, the activity on the first link (where beacon was received and indicated a Quiet Period for TWT) is forbidden. Therefore, another EML link could be used to be active during that while.

Thereafter, in line with the EMLSR mechanism, after an EMLSR active switch delay 499, the non-AP STA is scheduled to switch from the EMLSR listening operation mode to the EMLSR frame exchange mode with a view of putting one of the EMLSR co-affiliated STA operative for the frame exchange in a link distinct from the forbidden first link. The EMLSR co-affiliated STA including the first link 151 where the STA A1 has received the beacon frame are disabled.

In the example, the EMLSR co-affiliated STA A2 is switched from the listening operation state 411 to the enabled frame exchange state 651, while in parallel (synchronously or simultaneously) the transmitting EMLSR co-affiliated STA A1 is switched from the listening operation state 410 to the disabled frame exchange state 650.

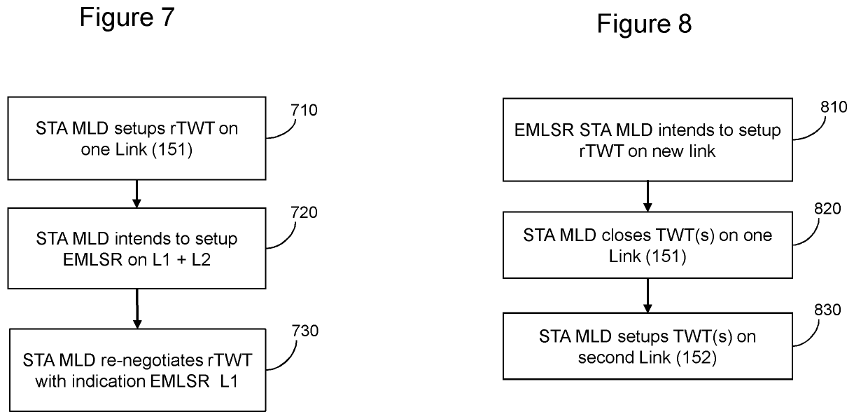

FIGS. 7 and 8 illustrate, using flowcharts, steps performed by an EMLSR-active non-AP MLD to setup a TWT service. Basically, they detail step 510 in order to determine the EML co-affiliated STA(s) allowed to negotiate a Link service.

FIG. 7 provides guidance when a TWT service is already setup before the EML operation is going to be activated.

As example, the non-AP MLD has one TWT service established on Link 151, for co-affiliated STA A1 (step 710).

The step 720 corresponds to step 500, where the non-AP MLD intends to operate in the EMLSR/EMLMR mode, meaning EML Operating Mode Notification frames activating the EMLSR/EMLMR mode is successfully transmitted the non-AP MLD 120, indicative of affiliated STAs A1 and A2.

Step 730 aims to indicate to the AP that one of EML Links has to be monitored for both EML operation and per-Link mechanism (e.g. TWT-like) according to embodiments. Aim of such an indication is for the AP to avoid link conflict for monitored events. In embodiments, as the AP MLD is controlling the TWT and beacon schedules on all its active links, MLD AP is alerted to avoid scheduling TWT SPs for EMLSR STAs that overlap beacons on other EMLSR links. In other words, the non-AP MLD transmits to the AP MLD an indication to schedule, in future beacon frames, service periods for the non-AP MLD (on the first link) that do not overlap in time any beacon frame transmitted by the AP MLD over a second link of the EML links. Such indication ensures for the non-AP MLD that it will be able to receive the beacon frames over the second link 152, regardless of the service periods scheduled on the first link 151.

As exemplary support of such indication, the bit B15 (338) of TWT Request subfield 331 of TWT Element 300. Thus, an “EML” field 338 can indicate whether or not the TWT SP indicated by the TWT element 300 operates over a link where EML operating is enabled and the non-AP MLD originator of the TWT element requests assistance of the AP for avoiding EML link conflict. (AP is requested to avoid scheduling r-TWT SPs for EML STA that overlap beacons on other EML links).

FIG. 8 briefly describes steps carried out by the non-AP MLD which intends to limit the use of TWT service over a given number of links. Even if management of more links is possible, it may seem complicated and inefficient (due to too many switching of EML active/suspend periods).

In step 810, the EML non-AP MLD is already operating in EML (EMLSR or EMLMR) mode. The non-AP MLD receives an internal request (e.g. from local application above the MAC) to open a new TWT service. By increasing the number of Links where EML events (step 550) are scheduled, this could force regularly the EML operating modes according to previous embodiments (Cases A to C in previous figures). Therefore, the non-AP MLD may be requested to suspend existing TXOPs more often. This could also be frequent when TBTT intervals of links are short.

If the number of links is greater than a desired number, the non-AP MLD can refuse any new (r)TWT of another link. Algorithm would stop. Otherwise, the non-AP MLD may close existing TWT service(s) on a first link (step 820), and re-install it (them) on a second link in addition to the new incoming TWT service (step 830). As examples of FIGS. 6a to 6c, this would mean all TWT services would be arranged on a single link, let us say link 151.

In summary, the above-described embodiments provide that if a STA that is affiliated with a non-AP MLD intends to receive the Beacon frame scheduled at a TBTT on one (first) link of its EML (EMLSR or EMLMR) links, the non-AP MLD shall be able to listen on the EML (EMLSR or EMLMR) links. Therefore, it shall satisfy the following rules:
if other STA affiliated with the same non-AP MLD successfully obtains a TXOP on the other link of the EML (EMLSR or EMLMR) links, then it should end its TXOP before the TBTT of that (first) link; (see FIG. 6a, case A)
if same STA affiliated with the same non-AP MLD is part of a TXOP on the intended (first) link of the EML (EMLSR or EMLMR) links, then it may remain in awake state on that link until TBTT; (see FIG. 6b, case B)
any STA affiliated with the same non-AP MLD that is in listening on the EML (EMLSR or EMLMR) links, shall ignore any initial Control frame addressed to it that overlaps the TBTT on the intended (first) link (i.e. that overlaps in time the beacon frame transmitted at TBTT on the first link).

The receiving of beacon frames on one EML (EMLSR or EMLMR) link is to be satisfied if one of the following conditions is met:
a TWT or rTWT agreement is established on that EMLSR link.
Quiet element corresponding to quiet intervals is scheduled to protect r-TWT SPs.

FIG. 9 schematically illustrates an EMLSR capable architecture for an MLD. This Figure takes the example of two affiliated non-AP STAs sharing the hardware resources of their non-AP MLD when the EMLSR mode is activated. The EMLSR capable architecture for an MLD presented in this Figure is for illustrative purpose only and other alternative architectures may be contemplated.

The architecture comprises two radio stacks, a Light radio stack and a Full radio stack.

The full radio stack comprises a full 802.11be MAC module 900a (exchanging data with higher layers), a full 802.11be PHY module 905a connected with the full MAC module, a full radio-frequency chain 915a connected with the full PHY module and the antennas 920a connected with the full RF chain through an EMLSR switch 910.

The light radio stack comprises a light 802.11be MAC module 900b (exchanging data with higher layers), a light 802.11be PHY module 905b connected with the light MAC module, a light radio-frequency chain 915b connected with the light PHY module and the antennas 920b connected with the light RF chain through the EMLSR switch 910.

The EMLSR switch 910 is shared by the two radio stacks and configured to switch, when the EMLSR mode is activated, the EMLSR co-affiliated STAs from/to Listening operation state to/from Enable or Disable Frame Exchange states.

The radio chain 900a/905a/915a is a full radio resource allowing reception and transmission of any IEEE802.11 frames. In particular, it includes encoding and decoding modules to encode and decode any IEEE802.11 frames. On the other hand, the radio chain 900b/905b/915b is a reduced function (or “light”) radio resource which only allows reception and transmission of specific IEEE802.11 frames. In particular, it only includes encoding and decoding modules to encode and decode specific frames using a rate of 6 Mbps, 12 Mbps, or 24 Mbps.

The diagram on the bottom left illustrates the functioning of the MLD when the non-AP MLD is in the EMLMR listening operation mode: the common EMLSR switch 910 connects each radio chain 900a/905a/915a and 900b/905b/915b to antennas 920a and 920b, respectively. Hence, each radio stack can be used to simultaneously listen to a respective link. As shown in the Figure, two links are available. The full radio chain 900a/905a/915a and antennas 920a are configure to operate on the Link1, the light radio chain 900b/905b/915b and antennas 920b are configured to operate on the Link2.

The diagram on the bottom center illustrates the functioning of the MLD when the non-AP MLD switches in a first EMLSR frame exchange mode. The EMLSR co-affiliated STA corresponding to Link 1 is in the enabled frame exchange state, while the other EMLSR co-affiliated STA corresponding to Link 2 is in the disabled frame exchange state. In that case, the common EMLSR switch 910 connects the full radio chain 900a/905a/915a to both antennas 920a and 920b and the full radio chain 900a/905a/915a and antennas 920a/920b are configured to operate on the Link1. Here, as the full radio chain remains configured to operate on Link 1, the EMLSR switch duration from Listening operation state to Enable frame exchange state may be considered as short. Indeed, in this case, the switch only involves an antenna switch. In the meantime, the common EMLSR switch 910 disconnects the light radio chain 900b/905b/915b from the antennas 920b. In this configuration, the light radio chain 900b/905b/915b is not able to received or transmit any frame on Link 2. Then, only Link 1 is available.

The diagram on the bottom right illustrates the functioning of the MLD when the non-AP MLD switches in a second EMLSR frame exchange mode. The EMLSR co-affiliated STA corresponding to Link 2 is in the enabled frame exchange state, while the other EMLSR co-affiliated STA corresponding to Link 1 is in the disabled frame exchange state. In that case, the common EMLSR switch 910 connects the full radio chain 900a/905a/915a to both antennas 920a and 920b and the full radio chain 900a/905a/915a and antennas 920a/920b are configured to operate on the Link2. Here, as the full radio chain switches to operate on Link 2, the EMLSR switch duration from Listening operation state to Enable frame exchange state may be considered as long. Indeed, in this case, the switch involves both an antenna switch and the full radio chain configuration switch. In the meantime, the common EMLSR switch 910 disconnects the light radio chain 900b/905b/915b from the antennas 920b. In this configuration, the light radio chain 900b/905b/915b is not able to received or transmit any frame on Link 1. Then, only Link 2 is available.

The functioning of the common EMLSR switch 910 clearly shows that the change of states for two EMLSR co-affiliated STAs in the same MLD is necessarily simultaneous because the radio chain is either connected to one of the STAs or to the other, but never remains available for both STAs at the same time.

FIG. 9a schematically illustrates an EMLMR capable architecture for an MLD. This Figure takes the example of two affiliated non-AP STAs sharing their antenna resources when the EMLMR mode is activated.

The architecture comprises two radio stacks, one for each non-AP STA.

A radio stack comprises a full 802.11be MAC module 900a′ or 900b′ (exchanging data with higher layers), a full 802.11be PHY module 905a′ or 905b′ connected with the MAC module, a radio-frequency chain 915a′ or 915b′ connected with the PHY module, an EMLMR switch 910′ shared by the two radio stacks and configured to perform the aggregation of the antenna resources when the EMLMR mode is activated, and an antenna array 920a′ or 920b′.

The diagram on the bottom left illustrates the functioning when the non-AP MLD is listening to an initial frame: the common EMLMR switch 910′ connects each antenna array to its RF chain. Hence, each radio stack is complete and can serve a respective link using for example a 2×2 MIMO antenna configuration. As shown in the Figure, two links are available.

The diagram on the bottom center illustrates the functioning of the MLD when the non-AP MLD switches in a first EMLMR frame exchange mode. The EMLMR co-affiliated STA corresponding to Link 2 is in the enabled frame exchange state, while the other EMLMR co-affiliated STA corresponding to Link 1 is in the disabled frame exchange state. The common EMLMR switch 910 aggregates the antenna resource to Link 2. To do so, it connects the antenna array 920a′ of the second radio stack to the RF chain 915b′ of the first radio stack. Hence, the first radio stack can operate in a 4×4 MIMO antenna configuration to improve the throughput over Link 2. On the other hand, Link 1 can no longer be used as its antenna array 920a′ is no longer available for the second radio stack.

The diagram on the bottom right illustrates the functioning of the MLD when the non-AP MLD switches in a second EMLMR frame exchange mode. The EMLMR co-affiliated STA corresponding to Link 1 is in the enabled frame exchange state, while the other EMLMR co-affiliated STA corresponding to Link 2 is in the disabled frame exchange state. The common EMLMR switch 910′ aggregates the antenna resource to Link 1. To do so, it connects the antenna array 920b′ of the first radio stack to the RF chain 915a′ of the second radio stack. Hence, the second radio stack can operate in a 4×4 MIMO antenna configuration to improve the throughput over Link 1. On the other hand, Link 2 can no longer be used as its antenna array 920b′ is no longer available for the first radio stack.

The functioning of the common EMLMR switch 910′ clearly shows that the change of states for two EMLMR co-affiliated STAs in the same MLD is necessarily simultaneous because the antenna resources are either connected to one of the STAs or to the other, but never remain available for both STAs at the same time.

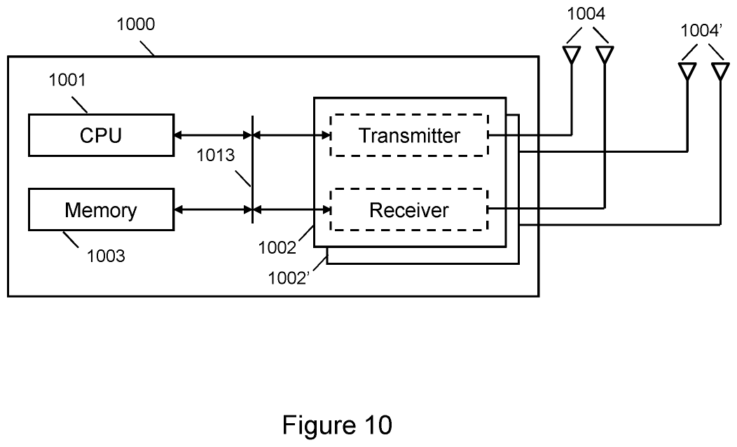

FIG. 10 schematically illustrates a communication device 1000, typically any of the MLDs discussed above, of a wireless network, configured to implement at least one embodiment of the present invention. The communication device 1000 may preferably be a device such as a micro-computer, a workstation or a light portable device. The communication device 1000 comprises a communication bus 1013 to which there are preferably connected:
a central processing unit 1001, such as a processor, denoted CPU;
a memory 1003 for storing an executable code of methods or steps of the methods according to embodiments of the invention as well as the registers adapted to record variables and parameters necessary for implementing the methods; and
at least two communication interfaces 1002 and 1002′ connected to the wireless communication network, for example a communication network according to one of the IEEE 802.11 family of standards, via transmitting and receiving antennas 1004 and 1004′, respectively.

Preferably the communication bus 1013 provides communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk or on a removable digital medium such as for example a disk. According to an optional variant, the executable code of the programs can be received by means of the communication network, via the interface 1002 or 1002′, in order to be stored in the memory of the communication device 1000 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising, at a non-access point, non-AP, multi-link device, MLD operating in an Enhanced Multi-Link, EML, mode that applies in a set of EML links:
receiving, by a first affiliated station, a first beacon frame over a first link of the EML links, the first beacon frame including a Target Beacon Transmission Time, TBTT, related to a second beacon frame; and
configuring the first affiliated station to be in a receiving state at the TBTT to receive the second beacon frame.

2. The method of claim 1, wherein configuring the first affiliated station includes ending an on-going frame exchange over a second link of the EML links and switching the first affiliated station into an operation state compliant with receiving the second beacon frame.

3. The method of claim 2, wherein switching into the operation state compliant with receiving the second beacon frame includes switching the first affiliated station into a listening operation state.

4. The method of claim 3, wherein a second affiliated station ignores any initial frame that triggers a frame exchange sequence over the second link that overlaps in time the first beacon frame on the first link.

5. The method of claim 2, wherein switching into the operation state compliant with receiving the second beacon frame includes switching the first affiliated station into an enabled frame exchange state.

6. The method of claim 1, wherein configuring the first affiliated station includes switching the first affiliated station from a listening operation state into an enabled frame exchange state.

7-9. (canceled)

10. The method of claim 1, wherein configuring the first affiliated station is triggered at least a first determined delay before the TBTT.

11. The method of claim 10, wherein the first determined delay belongs to the group comprising: an EMLSR active switch delay, an EMLMR active switch delay and a maximum of the EMLSR and EMLMR active switch delays.

12. (canceled)

13. The method of claim 1, wherein the second beacon frame schedules a service period on the first link, and switching the first affiliated station in an enabled frame exchange before the start of the service period and maintaining it in the enabled frame exchange state until the end of the service period.

14. The method of claim 12 or 13, wherein, at the end of the service period, switching the first affiliated station from the enabled frame exchange state to a listening operation state.

15. (canceled)

16. The method of claim 1, wherein the second beacon frame schedules a quiet period on the first link, and at a time of the quiet period, switching the first affiliated station to a disabled frame exchange state until an end of the quiet period.

17. The method of claim 16, wherein at the time of the quiet period, switching a second affiliated station to an enabled frame exchange state over a second link of the EML links until an end of the quiet period.

18. The method of claim 1, further comprising, by the non-AP MLD, transmitting to the AP MLD an indication to schedule, in future beacon frames, service periods for the non-AP MLD that do not overlap in time any beacon frame transmitted by the AP MLD over a second link of the EML links.

19. A communication method in a wireless network, comprising, at a non-access point, non-AP, multi-link device, MLD operating in an Enhanced Multi-Link, EML, mode that applies in a set of EML links:
configuring a second affiliated station to ignore any initial frame that triggers a frame exchange sequence over a second link of the EML links and that overlaps in time a beacon frame received by a first affiliated station over a first link of the EML links.

20. (canceled)

21. (canceled)

22. A wireless communication device comprising at least one microprocessor configured for carrying out the method of claim 1.

23. (canceled)

24. A communication method in a wireless network, comprising, at a non-access point, non-AP, multi-link device, MLD operating in an Enhanced Multi-Link, EML, mode that applies in a set of EML links:
configuring a second affiliated station not to perform frame exchanges over a second link of the EML links during a period of reception of a beacon frame by a first affiliated station over a first link of the EML links.
